(19) United States
(12) Patent Application Publication
(10) Pub. No.: US 2020/0191580 A1
(43) Pub. Date: Jun. 18, 2020

(54) STORAGE AND COLLECTION SYSTEMS AND METHODS FOR USE

(71) Applicant: Nordsense, Inc., Sunnyvale, CA (US)

(72) Inventors: Søren CHRISTENSEN, Hellerup (DK); Manuel MAESTRINI, Copenhagen (DK)

(73) Assignee: Nordsense, Inc., Sunnyvale, CA (US)

(21) Appl. No.: 16/800,445

(22) Filed: Feb. 25, 2020

Related U.S. Application Data
(63) Continuation of application No. PCT/US2018/048194, filed on Aug. 27, 2018.
(60) Provisional application No. 62/550,475, filed on Aug. 25, 2017.

(51) Int. Cl. G01C 21/34; G01F 23/292; G06Q 10/00; G06Q 10/04

(52) U.S. Cl. CPC G01C 21/343; G06Q 10/047; G06Q 10/30; G01F 23/292

(57) ABSTRACT

Systems and methods for managing the collection of contents from geographically distributed containers are disclosed herein. The systems can have a sensor in the container in data communication with a server system. The sensor can send data regarding the volume of contents in the container to the server system. The server system can then create routing information for a fleet of vehicles to empty the containers based on which containers are full enough for immediate collection, other predictive data for less full containers, and traffic and other routing factors for the vehicles. The server system can then transmit the routing information to the vehicles, track the vehicles, and prepare reports.

### CROSS-REFERENCE TO RELATED APPLICATION

This application is a continuation of International Application No. PCT/US2018/048194, filed Aug. 27, 2018, which claims priority to U.S. Provisional Application No. 62/550,475, filed Aug. 25, 2017, both of which are incorporated by reference herein in their entireties.

### BACKGROUND

Typical garbage collection entails a government or private organization sending out a fleet of vehicles, which are usually specially designed trucks, on a regular basis to collect the contents of distributed garbage bins in a particular geographic area.

Because the operators of the trucks do not know the quantity of contents of any bin before they arrive at and inspect the bin, they must stop their truck at every bin along their path and inspect every bin. Since the operators are scheduled to perform routes at a fixed frequency (e.g., route 1 would be performed once a week on Mondays), they will typically collect whatever contents are in the bin at that time they arrive, even if the contents are minimal, since they would not visit the bin again for a week.

In contrast, if the bin is not serviced frequently enough, the bin can overflow with waste, resulting in loose waste and pollution in streets and sidewalks, creating health and safety risks and diminishing the appearance of the area and value of the local real estate.

Similar processes exist for collection of other refuse container contents, such as for septic tanks, portable toilets (commonly referred to as port-a-potties), and other toxic waste collection.

This process of stopping at and inspecting every container on a fixed time frequency carries with it a number of inherent inefficiencies and other service issues. Operators' time is wasted by stopping, inspecting, and collecting contents form containers not in need of emptying. Operators are not able to empty the containers that fill up before their scheduled visit in a timely fashion resulting in overflowing containers—or the inability of users to dispose of refuse. The wear and tear and vehicles and equipment is accelerated due to the extra stops, collections, and distance traveled. This also causes increased carbon dioxide emissions, noise pollution, and traffic congestion.

Also, some containers on low frequency collection intervals are un-serviced for long periods of time despite being unexpectedly full. This can especially be a concern for portable toilets or other containers that fill at irregular rates, are located in remote or hard-to-access locations, or are otherwise expensive or difficult to manually service.

Accordingly, a system and method is desired that can better manage distributed container collections. A system and method for reducing the route distance, time, and stops for collection of contents of refuse containers is desired.

### SUMMARY

Systems and methods for monitoring and collecting contents of containers are disclosed herein.

A method for the collection of contents of one or more geographically distributed containers is disclosed. The method can include determining a fill level of the contents in one of the containers. The determining can include detecting the position of more than one point on the surface of the contents. The method can include transmitting to a server system the fill level of the contents and an identity of the one of the containers. The method can include calculating by the server system whether to include the container in a route data set defining a route. The route can have stops at one or more of the containers. The method can include creating the route data set and wirelessly sending the route data set from the server system to a mobile device.

The container can have one or more sensors for determining the fill level. The determining of the fill level can include forming a topography of the surface of the contents.

The method can include attaching a time of determination (e.g., a time stamp) in a data set with the fill level and the identity of the one of the containers. The transmitting can include transmitting the data set to the server system.

The method can include transporting along the route. The transporting along the route can include transporting a self-driving vehicle along the route. The mobile device can be in communication with a navigation system of the self-driving vehicle.

A system for the collection of contents of one or more geographically distributed containers is disclosed. The system can have one or more sensors for detecting the amount of contents in a container. The one or more sensors can have one or more detectors for detecting more than one point on the surface of the contents. The system can have a server system in wireless communication with the one or more sensors. The one or more sensors can transmit data to the server. The data can include data representing a fill level of the contents in the container. The system can have a mobile device in wireless communication with the server system. The mobile device can display instructions for routing a collection vehicle to the container.

The container can have a lid. A first sensor of the one or more sensors can be attached to the lid. The first sensor can be a time of flight sensor.

The first sensor can emit a first sensing energy. The first sensing energy can include a laser.

The one or more sensors can have a first sensor and a second sensor. The container can have a lid. The first sensor can be attached to the lid. The second sensor can be attached to the lid. The second sensor can emit a second energy that can include a laser or no laser energy.

The first sensor can be spaced at a distance from the second sensor. The second sensor can be attached to an inside wall of the body.

The first sensor can have a first emitter for emitting a first sensing energy and a second emitter for emitting a second sensing energy. The first emitter can be directed to a first point on the surface of the contents. The second emitter can be directed to a second point on the surface of the contents.

A device for fill volume detection is disclosed. The device can have a container having a body and a lid hingedly attached to the body. The container can contain contents constituting the fill volume within the container. The device can have a first sensor in the container. The first sensor can have a first emitter for emitting a first sensing energy, a first detector for detecting a reflection of the first sensing energy, and a first wireless radio. The first emitter can be directed so the first sensing energy is emitted in the direction of the surface of the contents.

The device can have a second sensor having a second emitter for emitting a second sensing energy, a second detector for detecting a reflection of the second sensing energy, and a second wireless radio.

The first sensor can have a second emitter for emitting a second sensing energy, and a second detector for detecting a reflection of the second sensing energy. The first emitter can be directed to a first point on the surface of the contents. The second emitter can be directed to a second point or the first point on the surface of the contents.

A method for fill volume detection is disclosed. The method can include emitting a sensing energy from a sensor in a container. The container can contain contents defining the fill volume within the container. The emitting can include directing the sensing energy to multiple points on the surface of the contents. The method can include detecting reflections of the sensing energy off of the multiple points of the surface of the contents. The method can include tracking the amount of time elapsed between the emitting of the sensing energy and the detecting of the reflections of the sensing energy. The method can include calculating a length associated with the amount of time for reflections of the sensing energy for each of the multiple points. The method can include forming a topography of the surface of the contents. The forming can include utilizing the calculated lengths to form the topography.

The method can include calculating the fill volume by at least processing the topography. The forming can include displaying a three-dimensional image.

The container can have a body and a lid hingedly attached to the body.

The emitting can include emitting from a first sensor in the container. The first sensor can have a first emitter for emitting the first sensing energy, a first detector for the detecting a reflection of the first sensing energy, and a first wireless radio.

Multiple sensors can be used per container. For example, multiple time of flight (TOF) cameras can be used to measure the content of a container. By using multiple cameras one would be able to obtain multiple points either originating from single points per camera or multiple points per camera. For example, five TOF cameras can be placed around a rectangular container—one to image each corner of the container and one to image the center of the container—to monitor the fill level in respective regions of the container. These points can be combined to build a topology of the content of the container, thereby determining the container's fill level. The system can estimate the fill level, for example, when contents of the container, such as solid waste, do not evenly fill the container from side-to-side. The resolution of the calculation of the fill level and topography of the surface of the contents can increase with the more emitters and detectors or sensors for the given container. The algorithms for combining the sensors can use simple image stitching, or voting algorithms to establish conditions where some or all of the sensors are reporting fill levels.

The system can use multi-point sensors. Each TOF camera can have, for example, about 16 sub-points of sub-pixels. Some TOF cameras can measure multiple points on the image. A virtual TOF camera can be built by combining multiple TOF cameras and obtain multiple points in the measurement. By using multiple points the system can build a topology map of the image observed by the camera (e.g., the surface of the contents of the container). The topology map can represent the fill pattern of the container. The system can estimate the fill level of containers where the contents have an irregular shape (e.g., solids, garbage bags, cardboard boxes). The system, for example via a multi-point TOF camera, can estimate the volume of the contents if the contents are evenly distributed across the container or all accumulate towards one side.

The system can have multiple types of sensors. One modality of sensor can be used with other types or modalities of sensors, for example, to establish fill levels and fill topology. For example, TOF cameras and weight sensors can be used together to calculate a volume and weight of the contents. The system can prompt collection a container that is at or near its limit for maximum volume or weight. Another example is that TOF cameras can be used with temperature sensors. As materials in the contents expand with rising temperature a corrected volume measurement can be produced by taking into account the temperature of the content of the container. The temperature of the container can be transmitted to the server system, and can be used to generate alerts independent of or associated with the fill level of the container. For example, the sensors can generate an alert if the temperature and/or temperature-time (i.e., measured in degree-hours) in the container exceeds a threshold temperature, regardless of the fill level of the container. The threshold level for the alert can be altered based on other sanitation issues (e.g., the presence of rodents and.or insects—such as detected by visual images and/or manually entered information from the operator or container owner; or decomposition rate or smells or detected fumes or gasses—such as detected by humidity, gas, pH detectors, or combinations thereof, in the sensor).

The sensor can have an accelerometer and a GPS sensor. If the sensor detects movement of the device via the accelerometer, the sensor can use the GPS sensor to determine the device's location. The location can be stored in a memory on the sensor and/or reported to the server. For example, the sensor can report its location to the server if the motion detected by the accelerometer exceeds a predefined threshold, indicating that the device has been moved from its mounting position on the container.

The sensor can turn on the TOF camera to measure the fill level of the container at specified intervals. For example, the sensor can measure the fill level at a timer interval set by the server system and stored in a memory in the sensor. When not measuring the fill level, the sensor can operate in a low power mode to conserve energy.

The fill level detected by the sensor can be dependent on placement of the device in the container, including the distance between the device and the bottom of the container and the orientation of the device with respect to the container. The server system and/or sensor can calibrate the sensor to compensate for the placement of the sensor within the container and the orientation of the container. For example, a baseline fill level reading can be transmitted to the server system when the sensor is first installed on an empty container. Future measurements received from the sensor can be compared to the baseline. Dimensions of the container can be manually entered at the server system (e.g., wirelessly via a device and an app) and compared to measurements taken by the sensor. The server system can perform the calibration or compensation, or can transmit parameters (e.g., a baseline fill level) to the sensor for calibration, or the sensor can store the parameters and perform the calibration without interacting with the server system.

The sensor can report data measured by the TOF camera or other sensor(s) to the server system. The sensor can report fill level measurements to the server when each measurement is taken or at a preset interval (e.g., once per day). The Sensor can store fill level measurements in sensor memory and send an alert to the server when a threshold fill level has been reached.

The server system can use the fill level measurements to schedule emptying of the container. The server system can send a notification to an individual responsible for emptying the container (i.e., an operator) when the container reaches a threshold fill level.

The server system can generate a schedule for an individual listing containers to be emptied, based on the fill level of the containers. The server system can add the container to an existing schedule when the container reaches a threshold fill level. The schedule to which the container is added can be based on location of the container (e.g., add the container to an operator's route or schedule with nearby containers), on other business logic rules such as timing for when an operator can be dispatched to the full container, or combinations thereof. If an operator is currently dispatched to empty containers in the region of a full container, the server system can dynamically modify the operator's pick-up schedule and route to add the newly reported full container.

The server system can predict when a container will be full by applying a regression model or machine learning/artificial intelligence to fill level data received from the sensor. For example, the server system can determine that a garbage truck scheduled to pass by a garbage container should empty the garbage container, even though the garbage container may be less than a threshold fill level, because the container will likely be overflowing before the next time the garbage truck is scheduled to pass the container.

The server system can transmit software updates as well as preset parameters to the sensor. For example, the server system can transmit a threshold fill level to the sensor, and can define an interval of time for measuring the fill level of the container. Firmware updates received by the sensor can be authenticated to the server system, for example, to reduce the likelihood of unauthorized third parties uploading their own code or configurations to the sensor.

The sensor, server system, and mobile devices can communicate using encrypted data. Data sent between the sensor, the server system, and the mobile device can be encrypted by an encryption algorithm such as public key encryption. The server can create a unique access point for each sensor and/or mobile device and configure each sensor and mobile device to communicate on its respective access point, for example, to reduce the likelihood that an unauthorized third party can find and abuse a server access point.

Fill levels for a container can be tracked over time (e.g., by a clock or time sensor on the sensor or server system). By comparing the measured fill levels to threshold fill levels, the server system can predict when a container needs to be serviced.

### BRIEF DESCRIPTION OF THE DRAWINGS

FIG. 1 illustrates a method for the collection of distributed containers' contents.

FIG. 2 illustrates a system for the collection of distributed containers' contents.

FIG. 3 illustrates a variation of a container.

FIGS. 4a, 4b, and 5 illustrate variations of cross-section A-A of FIG. 3.

FIG. 6 is a bottom perspective view of a variation of lid.

FIGS. 7 through 9 illustrate variations of cross-section A-A of FIG. 3.

FIGS. 10a and 10b are perspective views of variations of the sensor.

FIGS. 11a through 11c are top perspective, top, and bottom perspective views, respectively, of a variation of the sensor.

FIGS. 12a and 12b are perspective views of variations of the sensor.

FIGS. 13a and 13b are top perspective and top, and bottom perspective views, respectively, of a variation of the sensor.

FIGS. 13c and 13d are top perspective and top, and bottom perspective views, respectively, of the sensor of FIGS. 13a and 13b with a cover.

FIG. 14a is a top view of a variation of a circuit board in the sensor.

FIG. 14b is a simplified schematic view of a variation of a circuit board in the sensor.

FIG. 15 is a block diagram illustrating functional modules that can be executed by the sensor.

FIG. 16 is a flowchart illustrating a variation of a method for monitoring the fill level of a container using the sensor.

FIGS. 17a through 17e are variations of screenshots of an installation software for the sensor.

FIG. 18 illustrates a variation of a local network of adjacent sensors.

FIG. 19 is a screenshot of a display of data from sensors and an analysis thereof.

FIG. 20 through 22 are screenshots of variations of displayed reports of sensor data via the server system.

FIG. 23 is a screenshot of a variation of a display of real-time tracking of a collection operator on a collection route.

FIG. 24 is a screenshot of a variation of a display of a route summary and replay of a collection operator on a collection route.

FIG. 25 is a screenshot of a variation of a display of the selection of a group of sensors to combine their data during data analysis by the server system.

FIG. 26a is a screenshot of a variation of the navigator app showing available vehicles.

FIG. 26b illustrates a variation of the operator's mobile device displaying screenshots of the navigator app showing upcoming routes.

FIG. 26c is a screenshot of a variation of the navigator app showing a map with containers on the current route.

FIGS. 26d and 26e are screenshots of variations of the navigator app showing turn-by-turn instructions for a selected route.

FIG. 26f is a screenshot of a variation of the navigator app displaying turn-by-turn instructions for a selected route.

FIG. 26g is a screenshot of a variation of the navigator app displaying route and container information.

FIG. 26h is a screenshot of a variation of the navigator app displaying route information.

FIG. 27 is a variation of a screenshot of the navigator app displaying a trip summary report.

### DETAILED DESCRIPTION

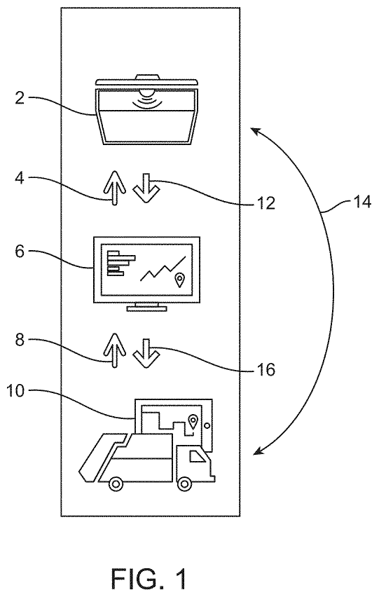

FIG. 1 illustrates that a method for collection of the contents 40 of distributed containers 32, such as trash bins or cans, septic tanks, portable toilets, toxic waste containers 32 (e.g., oil disposal drums), or combinations thereof, can include detecting the quantity of contents 40 in the container 32 (e.g., a fill level) by a sensor 2 in, on, or near a container 32. The sensor 2 can detect sensor data such as a fill-level of the contents 40 in the container 32, the orientation, geographical location, movement, and temperature of the container 32, remaining battery energy, or combinations thereof. One sensor can be used to detect sensor data for multiple containers 32, such as a group of bins at a single site or within a larger container 32.

The sensor 2 can wirelessly or otherwise (e.g., over a wired connection) communicate or transmit all or part of the sensor data to a server system 6, as shown by arrow 12. The server can analyze the sensor data. The server system 6 can calculate and predict trending of sensor data. The server system 6 can use the real-time (i.e., present) and historic sensor data trends to plan and assign collection routes 124 for the collection vehicles (e.g., garbage trucks, dump trucks, liquid containment trucks, flat bed trucks, pickup trucks, cars, bicycles, motorcycles, or combinations thereof), or operators otherwise (e.g., if on foot), and assign resources (e.g., number, types, and sizes of vehicles and/or operators) accordingly.

The server system 6 can transmit (send) the routing and resource assignment data to one or more mobile devices 10, as shown by arrow 16. The mobile devices 10 can be smartphones, computer tablets or laptops, on-board computers in vehicles, or combinations thereof. The mobile devices 10 can be executing navigation software (e.g., a mobile app) that can receive and display the routing and resource data. The navigation software can provide optimized, dynamic routes 124 with turn-by-turn navigation and spoken instructions that can incorporate real-time traffic data with the routing data from the server. The mobile devices 10 can display the routing information for the respective operator's mobile device 10. The mobile device 10 can be an on-board computer in a self-driving vehicle and can route the vehicle based on the routing data received from the server system 6.

Self-driving vehicles can follow the automatically route. Self-driving vehicles can stop at collection points for containers 32 on the route 124. Self-driving vehicles can await manual instructions to proceed after collection of a container 32, and/or await the weight of the vehicle to change for the container 32 contents 40 and the operator (if the operator left the vehicle) before proceeding along the route 124.

The mobile device 10 can collect and transmit location and collection (e.g., which containers have been collected, the weight and/or type of collected contents 40 from each container 32, the sensor data from the container's sensor) to the server system 6, as shown by arrow 8. The server system 6 can transmit data (e.g., software updates, ambient temperatures and forecast temperatures, sensing frequencies, or combinations thereof), to the sensor 4. The sensor 2 and the mobile device 10 can also directly transmit to each other, as shown by arrow 14, any of the aforementioned data or data listed below, for example during the container 32 collection when the mobile device 10 and sensor 2 are in proximity (e.g., within 10 meters) to each other over wired communication or a low power or close-proximity wireless communication (e.g., Bluetooth).

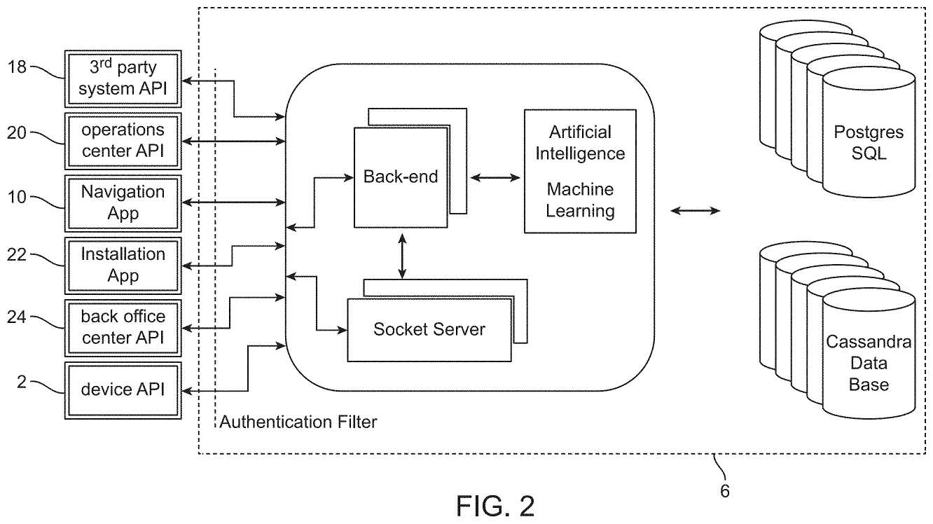

FIG. 2 illustrates that the architecture of the system can include a server system 6 that can have one or more socket servers in communication with one or more back-end servers. The back-end servers can execute artificial intelligence and machine learning algorithms on the data collected by the server system 6.

The server system 6 can communicate with and store and retrieve data from one or more databases, such as a Postgres SQL database and/or a Cassandra database.

Various APIs can communicate with the server system 6. When the APIs communicate with the server system 6, the communications can be authenticated through an authentication filter. The authentication filter can verify the identities of the devices executing the APIs can be verified to the server system 6.

Third party devices 18 can execute third party system APIs. The third party system APIs can, for example, access data available from the server system 6 for further analysis (e.g., a third party analysis of route information from the server system 6 combined with third party data on public traffic flow).

The operations center, such as for the collection entity (e.g., the trash collection company), can have an operations center device 20 (e.g., a server) on which operations center API software can be executed. The operations center API software can communicate with the server system 6 to get all of the data and reports otherwise available (optionally with the exception of some reports for the container owner) to the owner, mobile device 10, and server system 6. The operations center software can track the routing of collections vehicles in real time (e.g., via data from the navigation app).

The mobile device 10 and/or on-board vehicle computer can execute a navigation app. The navigation app can send routing, orientation, and vehicle status data for the vehicle from the server system 6. The routing app can record, track, display on the mobile device 10, and send vehicle location, orientation, and vehicle status data to the server system 6.

An installation app can be executed on the container owner's device 22 (e.g., a smartphone, tablet, desktop computer, laptop computer, or combinations thereof) (as shown), the mobile device 10, a container manufacturer's device, or combinations thereof. The installation app can link a sensor 2 to the server system 6 and set-up and calibrate the sensor 2 for use.

A back office center device 24 can execute a back office center API that can interact with the server system 6. The back office center device 24 can be used, for example, to remotely monitor and maintain the server system 6.

A device API can be executed on the sensor 2. For example, the device API can be executed by a processor on a circuit board 106 in the sensor 2, as described herein.

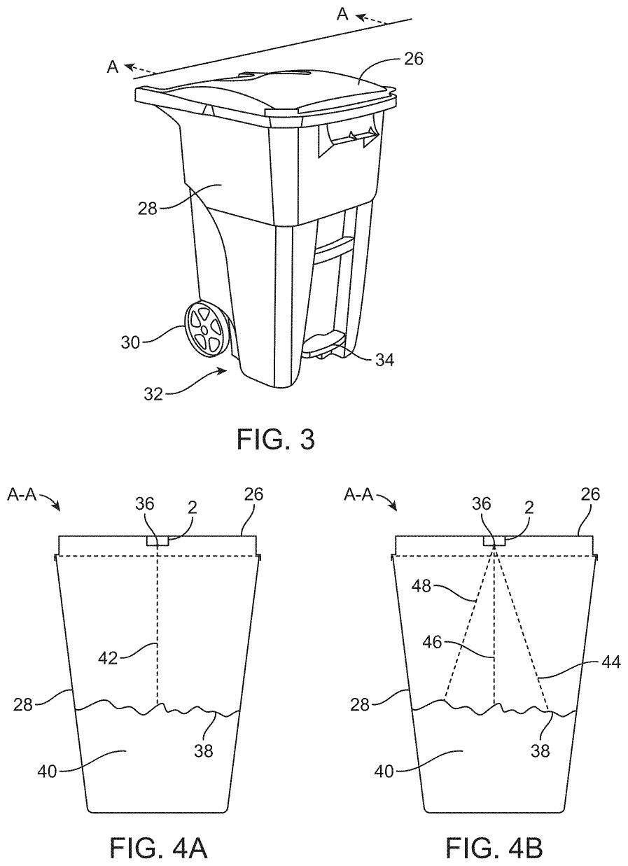

FIG. 3 illustrates a container 32, such as a trash bin, that can have a body 28 and an openable lid 26. The lid 26 can have a hinge and be rotatably attached to the body 28, as shown. The lid 26 can be a cap that can be screwed onto and off of the body 28. The container 32 can have no lid 26 or cap (e.g., the sensor 2 can be attached to a wall of the body 28 of the container 32, and exhaust tube, a nearby surface (e.g., pole) outside of the container 32, or combinations thereof. The lid 26 can be tethered to the body 28. The lid 26 can be non-porous, non-permeable by gas or liquid, gas permeable, liquid permeable, or combinations thereof. The lid 26 can latch to the body 28 to remain closed once closed unless manually opened. The lid 26 can lock closed to the body 28, for example, to only be openable by an individual having a key, combination, or other access device to unlock the lid 26.

The container 32 can have a lid controller 34 can actively open the lid 26 when activated. The lid controller 34 can be a foot pedal, hand button, or combinations thereof. The lid controller 34 can be a rotational gauge on the lid 26 that measures rotation of the lid 26 but does not actively open the lid 26. The activation of the lid controller 34 can send a signal to or through the sensor 2. The time, date, length, and amount of opening from the lid controller 34 can be recorded by the sensor 2 as part of the sensor data or communicated directly from the lid controller 34 to the server system 6 (e.g., over a wired or wireless connection).

The container 32 can have one or more wheels 30. The wheels 30 can be connected to the body 28 through a suspension, which can have an axle and/or one or more springs. The suspension can have a weight gauge (e.g., measuring strain of the axle, compression of the spring(s), or combinations thereof). The weight gauge can send a signal to or through the sensor 2. The weight—and/or merely the amount of change in weight—and associated time and date, and indications of change in weight and the amount of change in weight and their associated times and dates can be recorded by the sensor 2 as part of the sensor data or communicated directly from the weight gauge to the server system 6 (e.g., over a wired or wireless connection).

FIG. 4a illustrates that the container 32 can have contents 40 (e.g., solid and/or liquid refuse) that define a fill surface along the top surface of the contents 40. In a two-dimensional view, as shown in FIG. 4, the fill surface is projected as a fill line 38.

Fill levels and fill patterns can be measured in containers 32 using distance sensors mounted in, on, or near the containers 32. The sensor 2 can be mounted on the top of the container 32, the lid 26 of the container 32, or a mounting bracket placed on the container 32. For example, the lid 26 can have a sensor fixedly or removably mounted or attached to the side of the lid 26 facing the inner cavity, chamber or reservoir of the body 28 of the container 32 (in FIG. 4, this is the underside or bottom side of the lid 26).

The sensor 2 can be used to measure the fill level of containers 32 by measuring the distance to the contents 40 of the container 32 from the mounting position of the sensor 2. Depending on the configuration of the container 32, the sensor 2 may be mounted at an angle or aimed toward a particular area of interest in the container 32. The mounting of the sensor 2 can be fixed, or can be mechanically actuated to allow the camera to scan the container 32.

The sensor 2 can have one or more emitters 36 facing into the cavity, chamber or reservoir body 28 of the container 32. The emitter 36 can emit a sensing energy 42 into the body 28 of the container 32. The sensing energy 42 can reflect off of the fill line 38 and be detected by a sensing component (i.e., detector) of the sensor 2. The detector can be essentially located at the position of the emitter 36 (e.g., combined within as a single physical component on a circuit board 106).

The sensing energy 42 can reflect off of the surface of the contents 40 and/or transmit through the surface of, and possibly the remaining volume of the contents 40 (e.g., to be received by a detector on the opposite side of the container 32) and/or be absorbed by the surface of the contents 40. The sensing energy 42 can be an RF signal, such as a laser beam, radar (e.g., ultra wide-band radar), microwave, visible light, and/or ionizing radiation, such as X-rays, gamma rays, alpha particles, beta particles, or combinations thereof. Different sensors in the same container 32 can emit the same or different types of sensing energy 42. For example, a first sensor 52 in a container 32 can emit a laser and a second sensor 56 in the same container 32 can emit radar.

The sensor 2 can be a time-of-flight camera (TOF camera), a distance-sensing camera. A TOF camera can be a range imaging camera system that can resolve distance based on the known speed of light, measuring the time-of-flight of a light signal between the camera and the subject for each point of the image. A TOF Camera can detect the distance from the sensor to a single point on the fill area or many points on the fill area. A TOF Camera can be composed of a light source (i.e., emitter 36) and a detection system (i.e., detector). The TOF camera emitter can have or be a laser or other light source, such as a Vertical Cavity Surface Emitting Laser (VCSEL).

The TOF camera can produce a measurement that can be correlated to the distance between a point on the object being observed and the camera itself.

As mentioned elsewhere herein, the sensor 2 can communicate with the server system 6. The server system 6 can provide software updates and preset parameters to the fill monitoring device, and the fill monitoring device can send data describing fill levels of a container 32 to the server system 6 as well as other data measured or otherwise obtained by the sensor 2. The sensor 2 can report absolute and/or relative distances between the emitter 36 or distance sensor and contents 40 of the container 32 to the server.

FIG. 4b illustrates that the sensor 2 can perform multi-point sensing. The sensor 2 can emit first, second, and third sensing energies. Some or all of the sensing energies can be emitted be a single emitter 36 (as shown) at different angles, and/or each of the sensing energies can be emitted by its own emitter 36 in the sensor 2, with each of the emitters 36 directed in different directions. The sensing energies can each have the same type of energy (e.g., laser), or different types of energy (e.g., the first sensing energy 48 can be laser, the second sensing energy 46 can be radar, and the third sensing energy 44 can be laser). The sensing energies can be the same or different wavelengths or frequencies of each other. The sensing energies can each be directed at different points on the surface of the contents 40 and/or the inside wall of the container 32. Some of the sensing energies can be directed at the same points of the surface of the contents 40 (e.g., for a first sensing energy 48 to verify or supplement a second sensing energy 46, for example to supplement distance information from a first sensing energy 48 with a visual image from a second sending energy 46, and spectroscopy information from a third sensing energy 44). The reflection of the multiple sensing energies can be received by a single detector or multiple detectors in the sensor 2. The multiple detectors can be for detecting the same or different types or frequencies or wavelengths of energy.

In an example, a single emitter 36 can emit a first laser energy at a first wavelength of 700 nm in a first direction, a second laser energy at a second wavelength of 750 nm in a second direction, and a third laser energy at a third wavelength of 800 nm in a third direction. When the detector receives the reflected laser energies, the detector can distinguish between which of the laser energies is detected based on the wavelength of the reflection, and the sensor 2 can make a time of flight calculation (i.e., resulting in the distance from the sensor 2 to the surface of the contents 40) at multiple points along the surface based on the direction of the emitted energy.

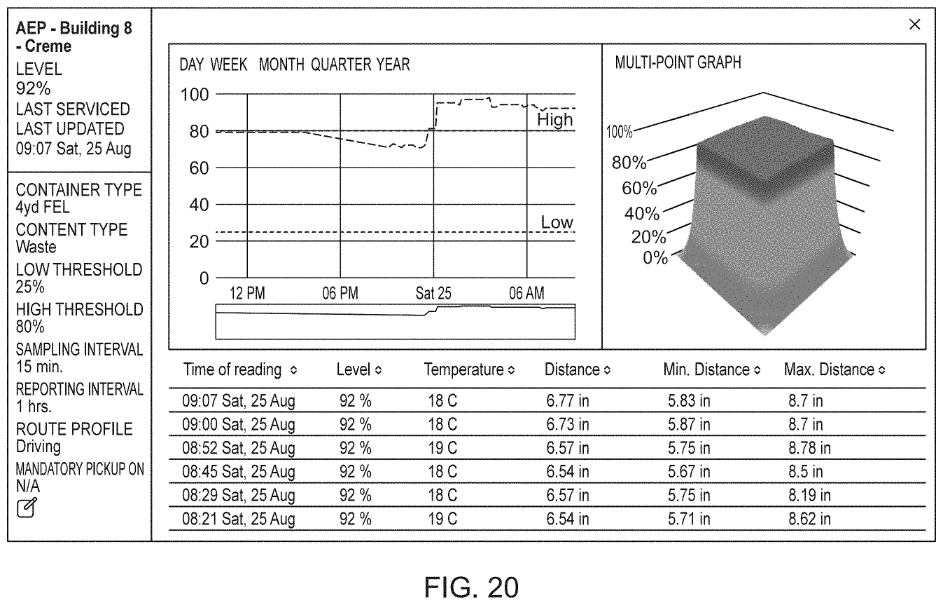

The sensor 2 can detect sub-points or sub-pixels with the multi-point sensing. The sensor 2, optionally or additional via processing by the server system 6, can form topographical data or a topographical image with the multiple distance data points along the surface of the contents 40, for example, calculating the weight distribution, curvature or contours at points, lengths, and areas along the surface, and density of the contents 40 (e.g., based on the irregularity of the top surface topography). The topography of the surface can be rendered as a three-dimensional graphical image and displayed (e.g., as shown in FIG. 20).

The multi-point sensor 2 can dynamically select which emitters and detectors 112 to use, for example, based on the consistency and lack of noise in the received signals from each emitter and detector 112.

The multi-point sensor 2 (and/or multiple sensors in a single container 32), can be used to detect the boundaries of the container 32 by analyzing the sensed data, and detecting the static elements in the data set over time periods where the fill line 38 changes. The sensor 2 can disable those points in the readings, for example, to avoid including static elements (e.g., representing the container 32 wall) into the data set that do not represent the desired fill level data. The sensor data analysis (e.g., by the sensor and/or the server system 6) can determine the static components and remove the static elements, filtering for the data representing the fill levels.

The sensors 2 can be mounted in a non-static (i.e., movable) way with respect to the container 32 (e.g., on a sliding lid, a sliding or rotating bracket, an extension arm, or combinations thereof).

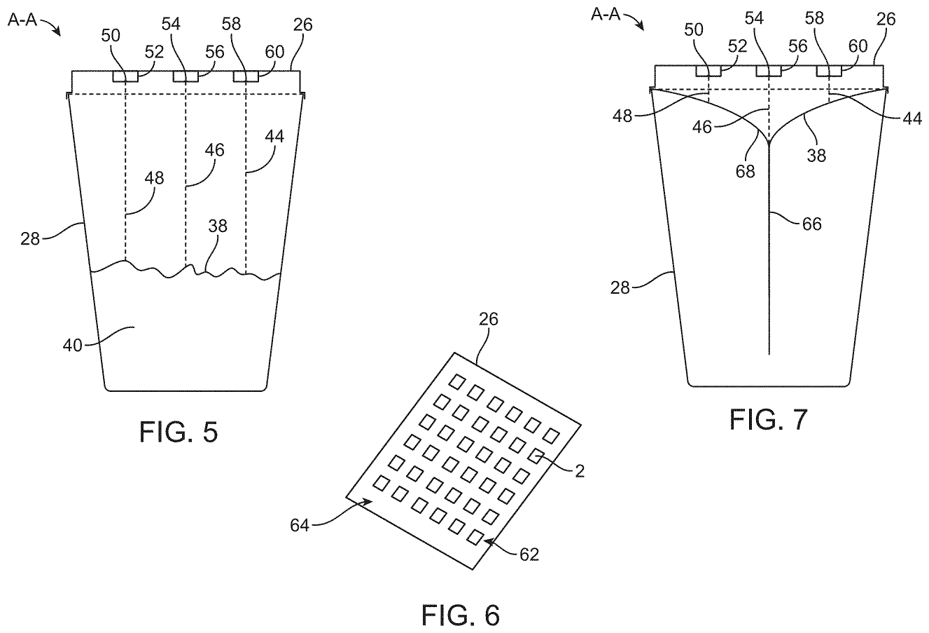

FIG. 5 illustrates that the lid 26 can have multiple sensors, such as first through third sensors 60, having multiple emitters and detectors 112, such as the first through third emitters 58, as shown. The multiple sensors can detect at least one extra dimension of the fill level surface. Also, if the container 32 has multiple chambers, at least one sensor can be positioned above each chamber to get at least one direct height data point for each chamber. The container 32 can have a single multi-point sensor positioned above the multiple chambers, for example, to detect the fill levels in each chamber with a single sensor.

FIG. 6 illustrates that the emitters 36 can be spatially distributed over the area of the lid 26 from left to right and front to back. For example, the sensors can be positioned in an orthogonal grid evenly distributed on the lid 26 with evenly spaced rows 62 and columns 64. FIG. 6 illustrates a six-by-six grid of 36 sensors. The lid 26 can have from one to 1,000 sensors, more narrowly from one to 10 sensors, yet more narrowly from 1 to 8 sensors, for example, 1, 2, 3, 4, or 5 sensors.

The sensors on a single lid 26 can be in data communication with each other, via wired or wireless data connections, for example forming a local area network, such as a mesh network. The sensors can transmit any or all of their sensor data to the other sensors on the same container 32 or same local network. All of the sensors on a single lid 26 can communicate with the server system 6, and/or a primary sensor can receive and optionally process data from the remaining sensors on a single lid 26, and the primary sensor can communicate all of the sensor data to the server system 6 and receive all data communication from the server system 6 and distribute the incoming data, as needed, to the remaining sensors on the lid 26.

Multiple sensors, and/or multiple emitters 36 on a single sensor, can sense a topography of the fill line 38. Sensors arranged along a single line (e.g., as shown in FIG. 5 if the sensors shown are the only sensors in the container, or as shown by a single row 62 or a single column 64 in FIG. 6) can produce a two-dimensional topography of the fill line 38. Sensors arranged in two-dimensions (e.g., as shown in FIG. 6) can produce a three-dimensional topography of the fill line 38.

FIG. 7 illustrates that a trash bag or other liner can be inserted into the container body 28. The bag can, for example, be pulled over or otherwise attached to the top rim of the container body 28. The bag can be originally packaged in a closed configuration. When inserted into the container 32, the length of the bag in a relaxed state may remain closed, for example due to static electrical forces holding the two sides of the bag together. The bag can have an opened bag length 68 near the top of the container 32 and a closed bag length 66 lower in the body 28 of the container 32. The fill line 38 can be defined by the opened bag length when no other contents 40 are in the container 32. The sensors and/or server can detect that an otherwise empty or almost otherwise empty but partially closed bag is in the container 32, for example, based on how recently the container 32 was emptied (e.g., as determined by the sensor data history, and/or the collection data history provided by the operators collecting the contents 40 of the container 32), the sensor data since the last emptying (e.g., if the fill line 38 has not moved or has moved downward since the suspected partially-closed bag was inserted into the container 32), the topography of the fill line 38, the activation of the lid 26, the change in weight of the container 32, or combinations thereof. If the sensor 2 and/or server system 6 concludes that a bag is in the container 32, future routing of collection of the contents 40 of the container 32 can be delayed until more contents 40 other than the bag are inserted into the container 32.

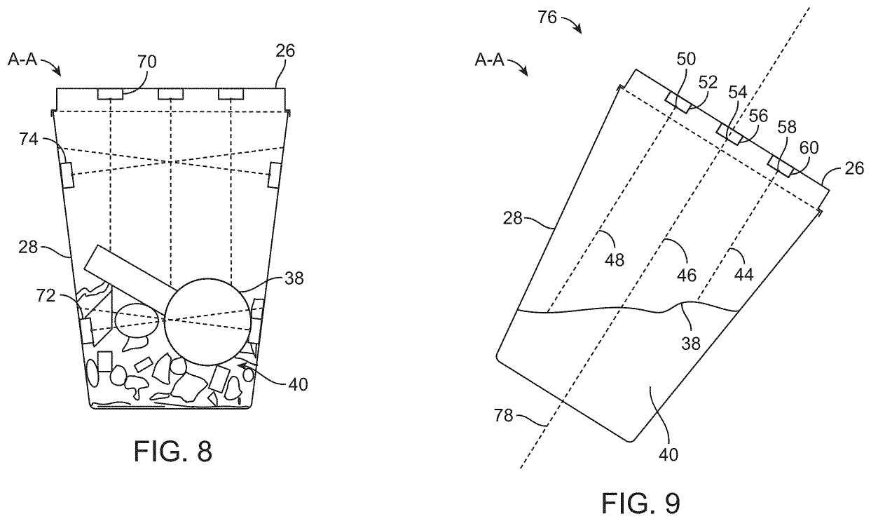

FIG. 8 illustrates that the sensors can be attached to the lid 26, as described above, and along the wall of the container 32. For example, the container 32 can have lid sensors 70, and upper body wall sensors 74, lower body wall sensors 72, or combinations thereof. The body wall sensors can be arranged in a grid along the wall, and/or can be positioned at equal heights and/or unequal heights with the other body wall sensors. The wall sensors can project sensing energy 42 in a lateral direction across the container 32 body 28 (e.g., being completely horizontal, or having a horizontal component with respect to the horizon or with respect to the undisturbed resting position of the container 32).

The sensors 2 can estimate the shapes of individual items within the contents 40. For example, the sensors 2 can detect the topography and the scattering of the sensing energy 42. The sensors 2 can detect the spectroscopy of reflected, and/or absorbed, and/or transmitted energy, for example to determine the materials of the contents 40. The sensors and/or server system 6 can calculate the volume of the contents 40 (e.g., the volume estimated by the fill surface or the volume calculated from a 3-dimensional map of the contents 40, inclusive of the contents 40 below the fill surface, created by the sensors and/or server system 6).

The content 40 of the containers 32 can be a number of different things, for example waste/trash including wrapped and unwrapped waste, liquids such as oil and water, sewer and slurry, clothing items, donations to charities either wrapped and unwrapped, recycling materials, human and animal food products, or industrial production materials, or combinations thereof.

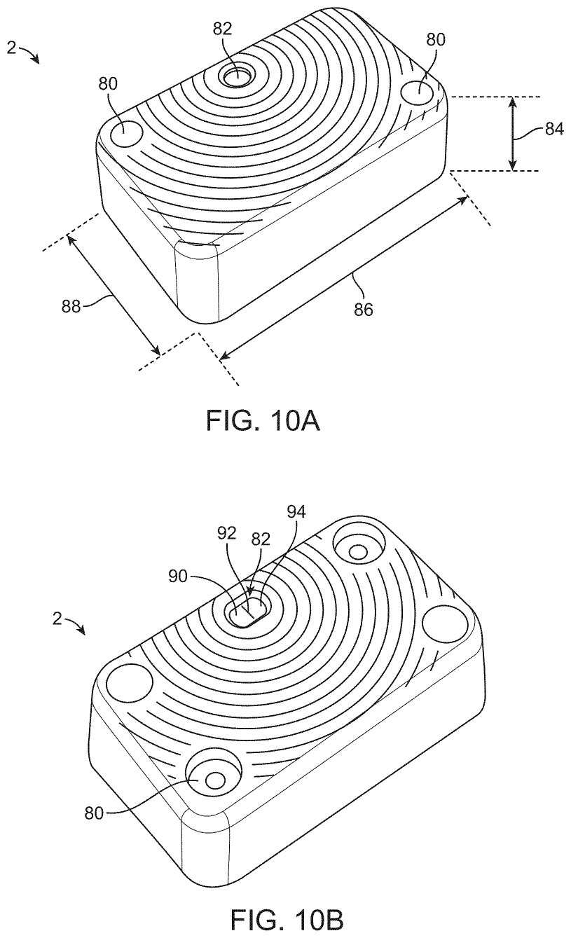

FIG. 9 illustrates that the container 32 can have a container vertical axis 78 (the vertical axis is the longitudinal axis for the container 32 shown in FIG. 9, but can be a lateral or other axis, such as for a container 32 that is a horizontally elongated tank). The vertical axis can be intended to be aligned and collinear with the direction of gravity 76. When the container 32 is tipped or rotated so the container vertical axis 78 is not collinear with gravity 76, the contents 40 and fill line 38 can shift in the container 32 due to the rotational acceleration and/or gravity 76. The sensor(s) can have one or more accelerometers and/or gyroscopic sensors for determining the vertical alignment of the container 32, and whether the container 32 is being agitated or otherwise shaken. The sensor(s) can detect a change of the fill line 38 topography and/or the average fill line 38 being at an angle with respect to the container vertical axis 78, for example, to determine the vertical alignment of the container 32. These data and determinations can be sensor data, and can be transmitted to the server system 6. The server system 6 can send data (e.g., via apps to an operator and/or the container 32 owner) that the container 32 has tilted and needs to be uprighted or otherwise re-aligned, and can indicate that the container 32 should be emptied sooner (e.g., to correct the alignment and/or to prevent premature overflow since additional the contents 40 will reach the lid 26 before the container 32 is as full as the container 32 would have been if the container 32 were upright or otherwise properly positioned).

The sensors 2 can calculate a weight distribution within the container 32, for example using the height of the detected fill line 38 across the container 32, the sensed sizes of the objects of the contents 40, the sensed materials of the contents 40, data inputted by the owner of the container 32 through an API to the server with information about the materials being deposited into the container 32, or combinations thereof.

The server system 6 can effectively split data from a single sensor into multiple virtual sensors.

The containers 32 can have (as described above) or not have a lid 26, such as an open-bed container 32. The sensor 2 can be mounted on a bracket attached to the container 32, or to a post placed in the vicinity of the container 32 such that the sensor 2 can measure the distance between its mounting point and contents 40 of the container 32. The distances measured by the sensor 2 can be adjusted to compensate for different placements of the sensor 2.

Each sensor 2 can be placed along the top of the container 32. The sensors can measure the distance from the sensor 2 to either the opposite side of the container 32, or to the closest object to the sensor 2. The fill level of the container 32 can be decided by, for example, a voting-like algorithm between different sensors in the container 32. A combination of these measurement techniques could be used.

The container 32 can be a compactor container 32 (a compressor container). For example, the container 32 can hold the contents 40 in a reservoir with one wall of the reservoir being defined by a front face of a compressor piston. The compressor piston can compress the contents 40 in the reservoir (e.g., a trash compactor). The sensor(s) can be used as described above and/or be mounted to the back face of a compressor piston, out of the reservoir holding the contents 40. The sensor 2 can measure the distance between its mounting position and the back side of the compression piston inside the container 32, thereby measuring the position of the piston and, by extension, the fill depth or height (if vertical) of the contents 40. The distances measured by the sensor 2 can be adjusted to compensate for different placements of the sensor 2 and the thickness of the piston plate.

The container 32 can be positioned fully or partially underground, for example, with an over ground entry point. The sensor 2 can either in the over ground entry point such that the sensor 2 can measure the distance between its mounting point and bottom the container 32. The sensor 2 can be mounted in the supporting structure above the container 32 itself, and measure the distance between its mounting point and the bottom of the container 32. The sensors and/or server can send an alert if the underground container 32 is producing sensor data indicating that the container 32 has been partially or completely removed from the ground.

The container 32 can be a slurry tank, portable and/or stationary toilet, other fluid tank, (e.g., water, recyclable oil), or combinations thereof. The sensor 2 can be in a ventilation pipe for the container 32.

The sensor 2 can have an extension, such as a pipe or rod, to interface (e.g., be submerged into or floating on) the contents 40 of the tank, keeping the sensor 2 raised above the container 32 top, preventing any contact between the contents 40 and the sensor 2.

FIG. 10 illustrates that the sensor 2 can have a generally rectangular or square cross-section in each dimension. The sensor 2 can have a sensor height 84 from about 10 mm to about 100 mm, more narrowly from about 15 mm to about 70 mm, for example about 22 mm, about 30 mm, about 50 mm, about 52 mm, about 59 mm, or about 60 mm. The sensor 2 can have a sensor length 86 from about 50 mm to about 150 mm, more narrowly from about 70 mm to about 125 mm, for example about 73 mm, about 97 mm, about 103 mm, or about 112 mm. The sensor 2 can have a sensor width 88 from about 20 mm to about 100 mm, more narrowly from about 30 mm to about 70 mm, for example about 30 mm, 41 mm, about 52 mm, about 55 mm, about 59 mm, or about 60 mm. The sensor can weigh from about 50 g to about 1000 g, more narrowly from about 80 g to about 500 g, for example about 100 g or about 310 g. The sensor 2 case can be made from metal and/or plastic, such as a thermoplastic polymer, for example ABS, and/or a polycarbonate. The sensor 2 case can be sealed liquid (e.g., water resistant) and/or dust-tight, for example rated IP65, IP66, IP 67, or IP68.

The sensor 2 can have one or more sensor ports 82. The sensor ports 82 can be circular. The sensor ports 82 can be on the top and/or on one or multiple sides of the sensor 2. (In reference to the sensor itself, the top side of the sensor can be pointed downward when attached to the lid 26. The bottom side of the sensor 2 can be attached to and thereby can be facing the surrounding surface, such as the lid 26 or container 32 wall.) The emitter and detector 112 can be in, extend from, or be positioned behind the sensor port 82. The emitted sensing energy 42 and reflected sensing energy 42 can pass through the sensor port 82.

The sensor 2 can have one or more attachment points or mounting holes, such as screw holes 80. Connectors, such as screws, bolts, brads, barbs, pins, spikes, snaps, rivets, or combinations thereof can extend from the sensor 2—for example, after being pushed through the screw holes 80—and fixedly or removably attach to an adjacent surface, such as the lid 26, the container 32 wall, the pole, a bracket (e.g., the bracket mounted to the lid 26 or pole), or combinations thereof.

All or part of the surface of the sensor 2 can have texturing, for example the top surface can have increasing-radius circular or semi-circular grooves or ridges concentrically centered at the sensor port 82.

FIG. 10b illustrates that the sensor port 82 can have a segmenting wall 92 dividing the sensor port 82 into a first emitter/detector opening 94 and a second emitter/detector opening 90. The first emitter 50 and detector can be in, flush with, or extend out of the first emitter/detector opening 94. The second emitter 54 and detector can be in, flush with, or extend out of the second emitter/detector opening 90.

Opposite corners and/or each corner of the sensor 2 can have one or more mounting hole (e.g., a screw hole 80).

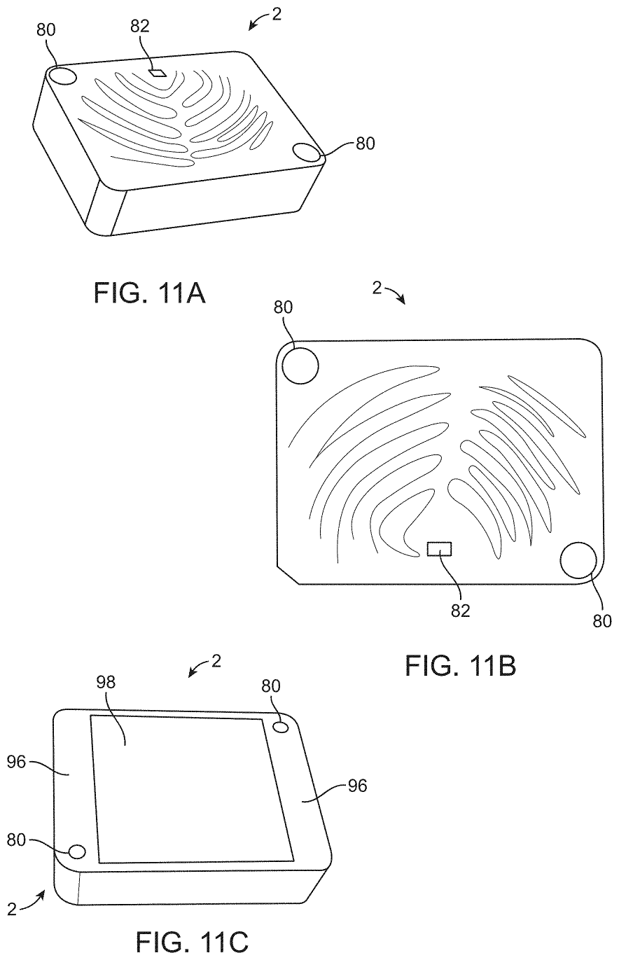

FIGS. 11a through 11c illustrate that the screw holes 80 can extend through the entire height of the sensor 2. The sensor port 82 can be rectangular, square, oval, circular, or combinations thereof. The bottom or base of the sensor 2 case can have a base recession 98. The base recession 98 can be surrounded on one, some, or all sides by a base shoulder 96. Adhesive and/or double-sided tape can be attached to the base recession 98 and/or the base shoulder 96. For example, the base recession 98 can be partially or completely filled with resin, epoxy, silicon, double sided tape, or combinations thereof, and then pressed against the attaching surface (e.g., container 32 lid 26, bracket, container 32 wall, pole) to attach the sensor to the lid 26. Connectors (e.g., screws, rivets) can be inserted through the screw holes 80 and attached to or through the attaching surface.

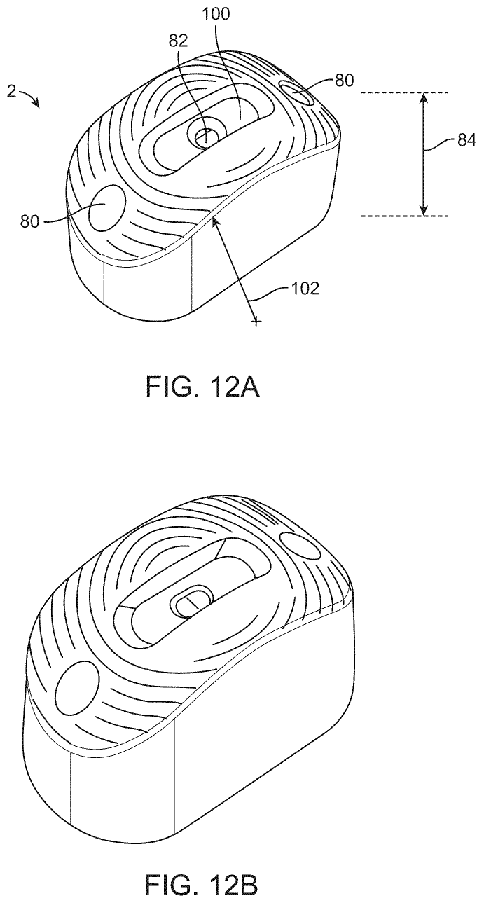

FIG. 12a illustrates that the top surface of the sensor 2 can be curved. The top of the sensor 2 can have a non-infinte radius of curvature 102, for example, the radius of curvature 102 can be from about 10 mm to about 100 mm, for example about 50 mm.

The sensor port 82 can be in a sensor cover recession 100, recessed below the surrounding surface of the sensor case.

FIG. 12b illustrates that the sensor port 82 can have a segmenting wall 92 dividing the sensor port 82 into a first emitter/detector opening 94 and a second emitter/detector opening 90. The first emitter 50 and detector can be in, flush with, or extend out of the first emitter/detector opening 94. The second emitter 54 and detector can be in, flush with, or extend out of the second emitter/detector opening 90.

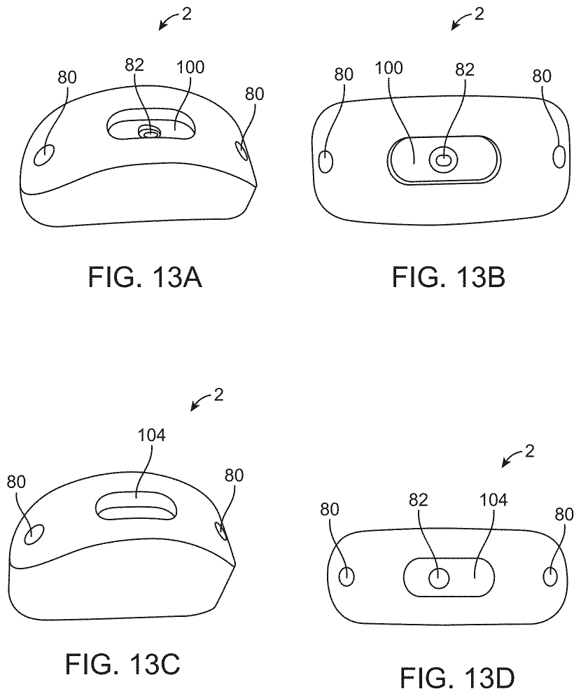

FIGS. 13a and 13b illustrate that the sensor 2 can be operated without a sensor cover 104.

FIGS. 13c and 13d illustrate that the sensor 2 can have a sensor cover 104 over the sensor port 82. The sensor cover 104 can be recessed within (as shown), flush with, or extend outward from the sensor cover recession 100. The sensor cover 104 can be over a lens of the emitter and/or detector. The sensor cover 104 can prevent liquid, particulars, or object impacts from contacting the emitter and/or detector. The sensor cover 104 can be transparent to the sensing energy 42. The sensor cover 104 can be polarized or non-polarized. The sensor cover 104 can be fixedly or removably attached to the remainder of the sensor case. For example, the sensor cover 104 can be replaced (e.g., when scratched or dirty).

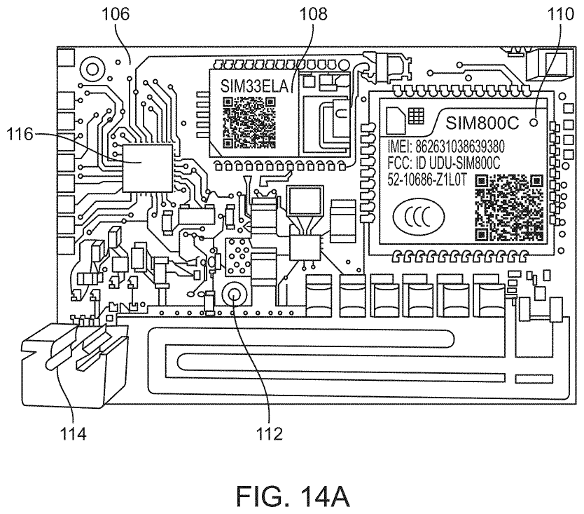

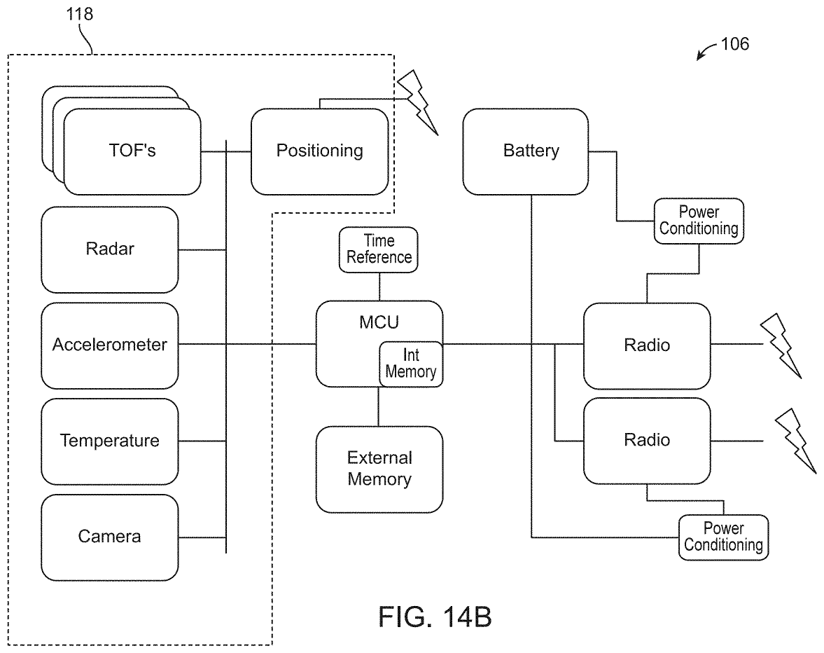

FIG. 14a illustrates an example printed circuit board 106 (PCB) of a sensor. The circuit board 106 can be in the sensor, within a cavity in the sensor case. The cavity holding the circuit board 106 can be water-tight and dust-tight or can have access to the surrounding environment, for example to measure characteristics of the environment (e.g., environmental temperature, environmental humidity, environmental pH), and/or contents 40 (e.g., content 40 pH, content 40 temperature).

The circuit board 106 can have a processor or controller. The processor can have non-transitory and/or transitory memory 116. The processor can execute software, for example, installed during manufacture and/or downloaded from the server system 6.

The circuit board 106 can have one or more location sensing modules, such as a wi-fi network-based location system, and/or a satellite-based radionavigation system, for example a GPS module 108. The location sensing module can have a GNSS antenna and/or a wi-fi antenna. The location sensing can be used for purposes described elsewhere herein and anti-theft tracking of the sensor and/or the entire container 32.

The circuit board 106 can have one or more wireless communication antennas 110, for example Bluetooth, wi-fi, cellular (e.g., PCS, GSM, 2G, 3G, 4G, CAT-M1, NB-IoT), or LoRa antennas, or combinations thereof. The circuit board 106 can have a fixed or replaceable SIM card.

The circuit board 106 can have one or more emitters and detectors 112. The emitter 36 can be configured to emit the sensing energy 42. The detector can be an optical sensor or a sensor for any energy modality mentioned herein. The detector can be configured to detect reflected and/or absorbed and/or transmitted and/or refracted sensing energy 42 from the emitter or emitters on other sensors (e.g., sensors in the same container 32). The emitter and detector 112 can measure a length to the content 40 surface with an accuracy of about 1 cm or about 1 mm. The emitter and detector 112 can have a resolution of up to about 1 mm. The emitter and detector 112 can have a range from about 0 to 5 m, more narrowly from about 0 to 2 m.

The circuit board 106 can have a battery (not shown, but can be positioned on the reverse side of the circuit board 106 shown in FIG. 14). The battery can be rechargeable. The battery can be replaceable. The battery life under typical use and environmental conditions can be from about 5 years to about 20 years, for example about 7 years or about 10 years.

The circuit board 106 can have one or more input and output connectors 114. The input and output connectors 114 can be connected to wired networks, additional emitters and detectors 112, other sensors' circuit boards 106, additional batteries, diagnostic electronics, additional environmental or content 40 sensing elements, or combinations thereof.

The circuit board 106 can have a speaker and/or a display (e.g., full video, lights, an LED, or combinations thereof), for example to flash, broadcast visual messages, chimes or alert tones based on actions and confirmations (e.g., identifying the sensor from an instruction in an app, warning of a low battery, confirming pickup of contents 40, alerting when the lid 26 is ajar and/or if the temperature or noxious gas sensors indicate the contents 40 are on fire), or messages (e.g., a voice message left by the container's owner for the collecting operator). Any message delivered on the speaker and/or display can also be included in the sensor data and transmitted to the server system 6 and/or the owner and/or operator's devices on their respective apps.

The circuit board 106 can have environmental and content 40 sensors (other than those mentioned above). For example, the circuit board 106 can have one or more temperature sensors (e.g., and can report immediately if the container 32 is outside a specified temperature range or if the contents 40 are on fire), accelerometers (e.g., for reporting container movement), gyroscopic or other orientation sensors, humidity sensors, pH sensors, toxic or noxious material sensors (e.g., for detecting toxic or corrosive gasses or liquids, or smoke in the event of a fire), physical separation sensor (e.g., attached to a spring-loaded pad on the sensor base to determine if the sensor has been removed from its attachment surface), or combinations thereof. The circuit board 106 can alert the server system 6 and/or through the speaker and/or owner's app if the temperature sensor detects a temperature below −25° C. or −40° C. or above 80° C. The circuit board 106 can operate in temperatures, for example, from about −25° C. to about 80° C.

The circuit board 106 can have an onboard fan and/or liquid cooling system, for example with a finned heat radiator. The circuit board 106 can be wrapped or coated in thermal insulation and/or anti-corrosion material.

The circuit board 106 can be configured to report sensor data at fixed or variable intervals. For example, the sensor, server system 6, and/or the owner can alter the reporting schedule based on the historical and current frequency of collections, rate of content 40 accumulation within the container 32, battery use and remaining life, and combinations thereof.

The sensor 2 can record video data for example still frames or moving videos (e.g., JPEG and/or MPEG files), audio data, or combinations thereof of the inside of the container 32 as part of the sensor data. These video and audio files with the rest of the sensor data can be used to train the artificial intelligence, for example to identify and send an alert to any or all of the APIs regarding contaminated waste streams (e.g., a plastic bag in a paper recycling container 32). The audio can be used to determine the topology of the fill surface by echolocation.

FIG. 14b illustrates that the circuit board 106 and/or other components in connection with each other can have a processor (MCU) with internal memory in direct communication and connection with external memory and a clock (time reference). The processor can be connected to multiple radios, a battery, and sensing components 118. The radios can send and receive wireless communications. The battery can directly power the radios through power conditioning components. The radios can connected to each other. The sensing components 118 can be TOF detectors and emitters, radar, accelerometers, temperature sensors, cameras, and positioning sensors, for example that send or receive positioning data wirelessly (e.g., from GPS satellites).

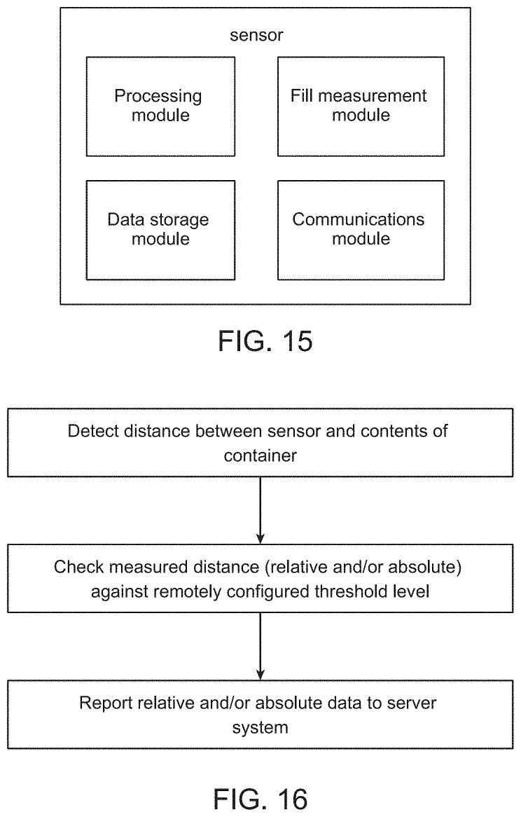

FIG. 15 is a block diagram illustrating functional modules that can be executed by the sensor. The functional modules executable by the sensor 2 can include a processing module, a fill measurement module, a data storage module, and a communications module. The processing module can collect data measurements from the sensor's sensing components 118, and can perform local processing and communications tasks on the sensor's components 118. The processing module can perform energy management for elements of the sensor 2, operating the device in an energy-efficient manner (e.g., increasing or decreasing the sampling frequency of the emitting and sensing components 118 and communications by the wireless communications components). The fill measurement module can perform tasks to calculate a fill measurement of the container 32 based on the data measurements received from the sensor components. The data storage module can store the sensed data measurements, calculated fill levels, and parameters for operating the sensor 2. The communications module can communicate with an external device, such as a remote server system 6. The modules executable by the fill monitoring device can be implemented in hardware and/or software.

FIG. 16 is a flowchart illustrating a method for monitoring the fill level of a container 32 using the sensor 2.

The sensors can be installed on containers 32 already in use (e.g., retrofit) or during the manufacture of new containers 32. To prepare the sensor 2 for use in a system, installation software (e.g., an installation app) on a remote device, such as the server system 6 or the container owner's device 22, can be executed to install the sensor 2 into the system.

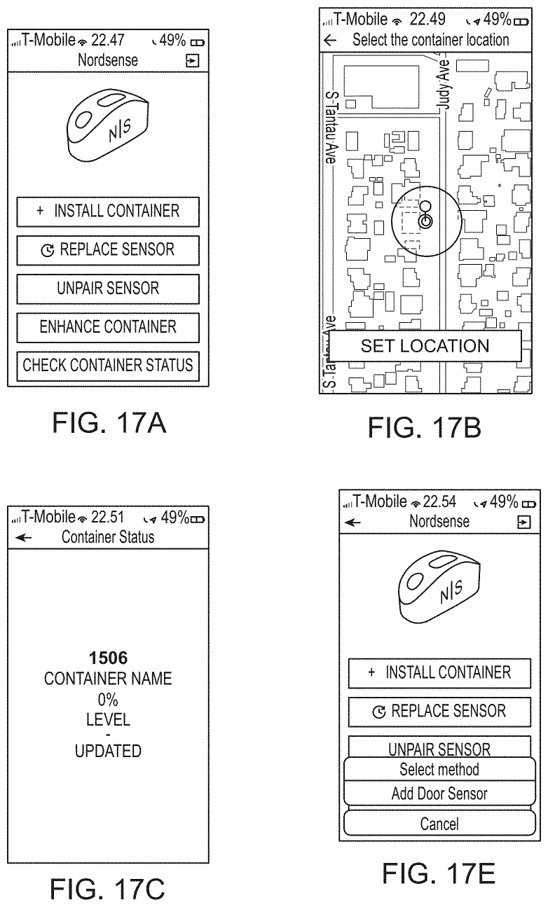

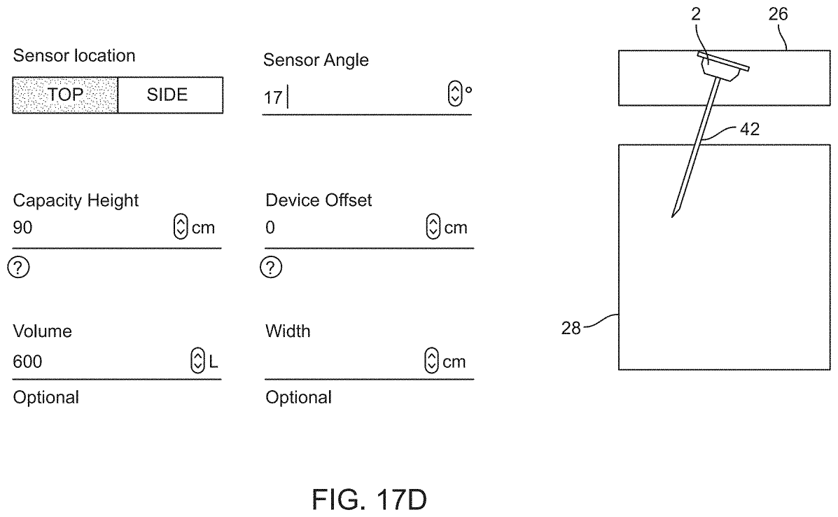

FIG. 17a illustrates that the installation software can install the sensor 2 for a new container 32, signal replacement of the sensor 2, unpair the sensor 2, enhance the location of the container 32, check the container 32 status, or combinations thereof.

During installation for a new container 32, the installation software can link the sensor 2 with a server system 6, location (e.g., address, as shown in FIG. 17b), type of container 32, and container 32 name (e.g., identifying number, as shown in FIG. 17c), sensor position in the container 32, the container 32 height, volume, width, and the sensor angle and offset from center (as shown in FIG. 17d—which also graphically shows the sensor position, angle of orientation, and relative container 32 dimensions), or combinations thereof. This installation information can be automatically attained by the sensor components on board the sensor and information from the server system 6, and/or can be manually entered or corrected by the user of the installation app.

The installation software can enhance the location of the container 32, for example, by showing the location of the container 32 on a map as designated by the selected street address or entered by the container 32 owner, and also overlaying the location of the container 32 as asserted by GPS information provided by the sensor 2, and the location of nearby sensors (e.g., if the sensor is on a container 32 that is in a close group of containers 32 each with its own sensor). The user of the installation app can then manually calibrate the location of the container 32 on the map in light of the available location data.

The installation software can unpair a sensor from a system, and can restore factory settings, deleting previously recorded sensed and server system data from the sensor. For example, the restoring of factory settings can be performed after the sensor is removed from a container 32 (in preparation for use on a new container 32 elsewhere, such as when resold or if the owner moves). The server system 6 and/or installation software can copy all of the old sensor data, including data described herein including location and identifying information, from an old sensor to a new sensor replacing the old sensor.

As shown in FIG. 17e, the installation software can link the sensor 2 to a door sensor, for example a doorbell or keypad on a door or gate. For example, a collection operator may need to key in a passcode to open a gate in order to access the container 32. The sensor 2 can communicate with the gate to alert the server system 6 and/or the owner's device when the operator's access code has been used on the gate. The sensor 2 can also make the gate's access code active when alerted by the server system 6 that the operator is nearby. The operator's gate code can remain inactive and unusable during other times.

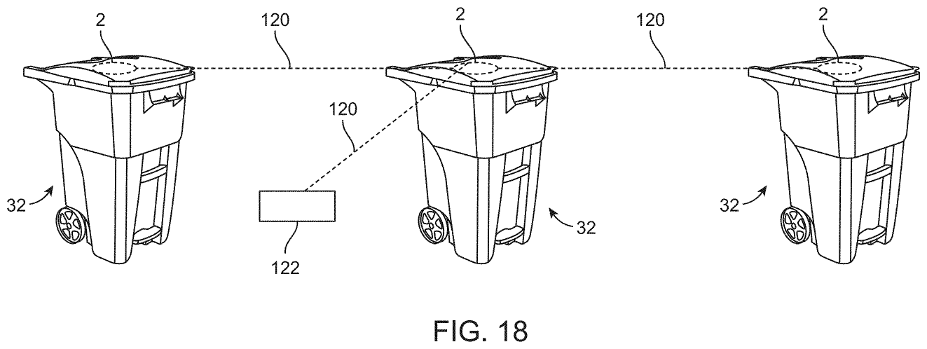

FIG. 18 illustrates that a group of containers 32 can each have a sensor. The containers 32 can be in close proximity to each other. The sensors can have a network connection 120 with the next closest sensor. All of the sensors in the group can be in wired or wireless communication with each other. For example, the sensors can for a local area network (e.g., over Bluetooth 5.0), such as a mesh network. All (e.g., for redundancy) or one of the sensors can act as a (e.g., cellular) network connection 120 to the server system 6 for the local network of sensors. A router 122 near the sensors can have a wired or wireless network connection 120 with one or more of the sensors. The router 122 can act as a (e.g., cellular) network connection 120 to the server system 6 for the local network of sensors. For example, the sensors can use their respective reduce the frequency of using their wireless radios for communication with the server system 6 when relating communications over the local network to the server.

Multiple sensors can be used in a single container 32. Door sensors or access controllers can be put on cabinets or cages holding containers 32.

The server system 6 can receive the sensor data from the sensor 2. The server system 6 can maintain a real-time overview of sensor data from all sensors. The sensor data can be validated and checked for data errors by the server system 6. The server system 6 can flag and report erroneous or extreme sensor data for further review by operations control, the container 32 owner, the operator, or combinations thereof. The server system 6 can flag sensors that are low on battery energy, appear to have dirty or failing sensors corrupting the sensor data, do not report data during an expected reporting period, or combinations thereof. The server system 6 can indicate to dispatch an operator to the sensor to clean, maintain, replace the batteries on the sensor, or combinations thereof.

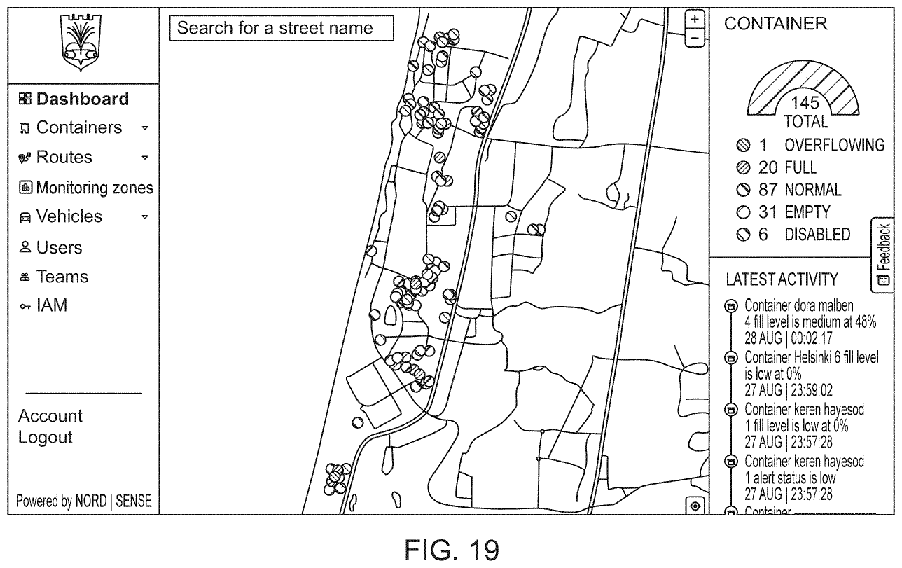

The server system 6 can interpret and analyze the sensor data. All or some data from all or some of the sensors and the analyzed and interpreted data can be made available from the server system 6 to display for any or all of the aforementioned APIs and apps via a data dashboard (e.g., a website, app, other software, or combinations thereof) as shown in FIG. 19. Similarly any alerts and data flags mentioned herein can be pushed to or otherwise available for display to any or all of the APIs and apps mentioned herein.

The data dashboard can display real-time and historical maps of the sensor locations, the current and historical container 32 fill levels, the ability to manually trigger urgent collection scheduling for specific containers 32 (e.g., “empty now”), notifications and flags from the server system 6 for urgent data and alerts and data errors.

FIG. 20 illustrates that the server system 6 can display sensor data and analysis from a selected container 32. For example, the display can have a three-dimensional color-coded topographical image reporting the fill surface and levels for the container 32. Historical fill levels are also graphed and displayed. Discrete sensing of the time and date of the reading, the fill level for the reading, the temperature for the reading, the (e.g., average) distance from the sensor to the content 40 surface, and the minimum and maximum distances for the sensors for the reading are also displayed. The container 32 type, content 40 category, minimum and maximum thresholds for the fill level, sampling interval for the sensor 2, reporting interval for the sensor 2 are shown. The method by which the operator collects the container 32 and whether there is a mandatory pickup at a particular time frequency are shown. The user can also edit the editable data (e.g., container 32 type, waste type, threshold levels, sampling and reporting intervals, route 124 profile, and mandatory pickup frequency).

Additional information from other sensor data can be shown (e.g., accelerometer events). The display can be customized by the user's API.

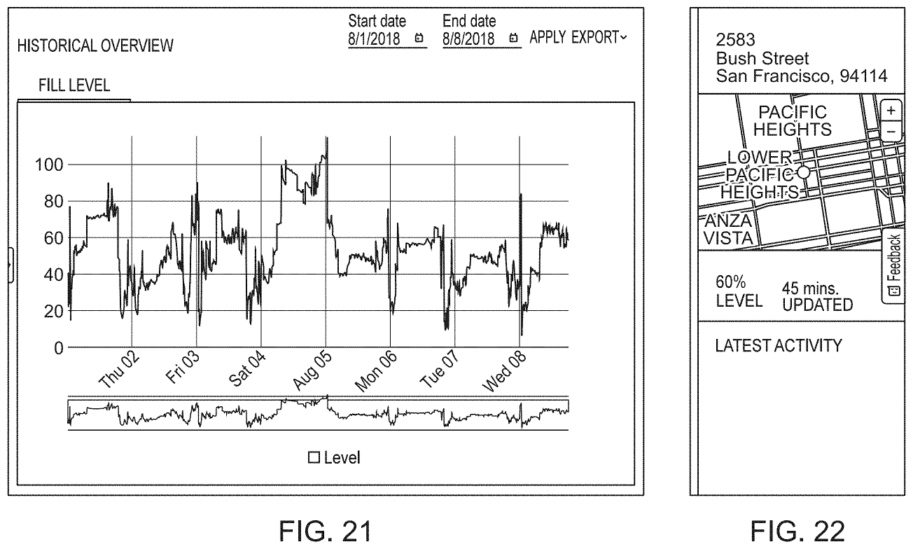

FIG. 21 illustrates a variation of the display for a container 32 presented to the APIs from the server system 6. The display can show the container's 32 historical fill height graphed for over 7 days.

FIG. 22 illustrates a variation of the display for a container 32 presented to the APIs from the server system 6. The display can show the address and mapped location of the container 32, the container's 32 fill level, and the last updating to the server system of the container's 32 data.

The server system 6 can have a hysteresis control on the fill level data so a preset number of data samples are registered above or below a threshold level before the server system 6 indicates (e.g., in collection route calculations and reporting to APIs) that the threshold has been crossed. The hysteresis control can, for example, minimize false positive readings from compressible contents 40 that need time to compress, or an item on top of the remainder of the contents 40 that will fall deeper into the container 32 in short time, but is causing an high fill level reading for a short period of time that is not reflective of the total volume of contents 40.

The server system 6 can allow users to manually tailor report data and presentation style (e.g., presenting data as a graph, table, or comma separated list) for displays.

Using the sensor data and external data, the server system 6 can create collection routes for each operator. The collection routes 124 can be dynamic and event driven. Containers 32 can be added to collection routes when the contents 40 of the specific containers 32 can be when the containers 32 are above a specified fullness threshold. The server system 6 can include current and predicted traffic conditions, current and predicted weather conditions, the day of the week, nearby events, existing traffic detours, road work areas, active school zones, other irregular traffic congestion (e.g., due to concerts, demonstrations, sports events), and combinations thereof in route planning. The server system 6 can also match the appropriate vehicle with the container 32, and/or weight, and/or volume, and/or waste type to be serviced. For example, the server system 6 can manage containers 32 that include mixed household waste, portable toilets, septic tanks, and biohazard containers 32, and can have vehicles that can process one or more types of the containers 32 and their respective waste, but not the others. During route planning, the server system 6 can incorporate navigation on accessible non-public streets and driveways (e.g., to which access is permitted), indoor locations, on-foot movement by the operator, routes across political (e.g., state borders), and physical boundaries (e.g., fences) and provide instructions for the operator through the navigator app when doing so.

The server system 6 can optimize routes in real-time, for example, changing routes for particular operators while the operator is mid-route. The updated route 124 can be transmitted from the server system 6 to the mobile device 10.

The server system 6 can employ artificial intelligence (AI) and machine learning to optimize route creation and predict future routes. The server system 6 can schedule pre-emptive collection of container 32 contents 40 when determined to be appropriate (e.g., for efficiency and/or effectiveness) by the routing (e.g., AI) models.

Operators' vehicles can be routed to arrive on the correct side of the road for accessing and transferring the contents 40 of the container 32. For example, a garbage truck may have a grappling arm for gripping the container 32, picking the container 32 up, positioning the container 32 upside down over the collection area in the truck, and shaking the container 32 to empty the contents 40 into the truck's collection area. If the arm only extends from the right side of the truck, the routing can be limited to orient each garbage truck so it arrives on the right side of the road when picking up a container 32 so the arm can be used without requiring a U-turn of the truck at the destination.

Operators' vehicles can have weighing components to track the weight of collected contents 40. The server system 6 can use the real-time collection vehicle diagnostic information from mobile devices 10 and other vehicle on-board diagnostics (e.g., to determine the weight of currently gathered contents 40) for reports, and to avoid exceeding road and vehicle weight restrictions during route—for example when in conjunction with the predicted weight of the remaining containers 32 to be collected during the route 124. The server system 6 can track other on-board vehicle diagnostics along with the weight of collected contents 40 to predict vehicle maintenance and alert operators and other personnel when vehicle maintenance is due and schedules or predicted future maintenance. When creating future routes, the server system 6 can take into account the available vehicle fleet based on predicted future maintenance and other servicing of vehicles.

The server system 6 can alert container 32 owners (e.g., via an app) when their container 32 needs to be pushed to the curb for pickup by the collection operator, for example, at a time length before their estimated collection set by the owner of the container 32 in their app, which can then be stored by the server system 6 for that owner's sensor 2.

The server system 6 can assess and regulate power consumption by each sensor 2, and alter the frequency of measurement and data transmission by each sensor 2 to increase battery life based on battery status, current and predicted weather conditions (e.g., temperature and humidity), signal strength, frequency of collections for the respective sensor 2, and combinations thereof.

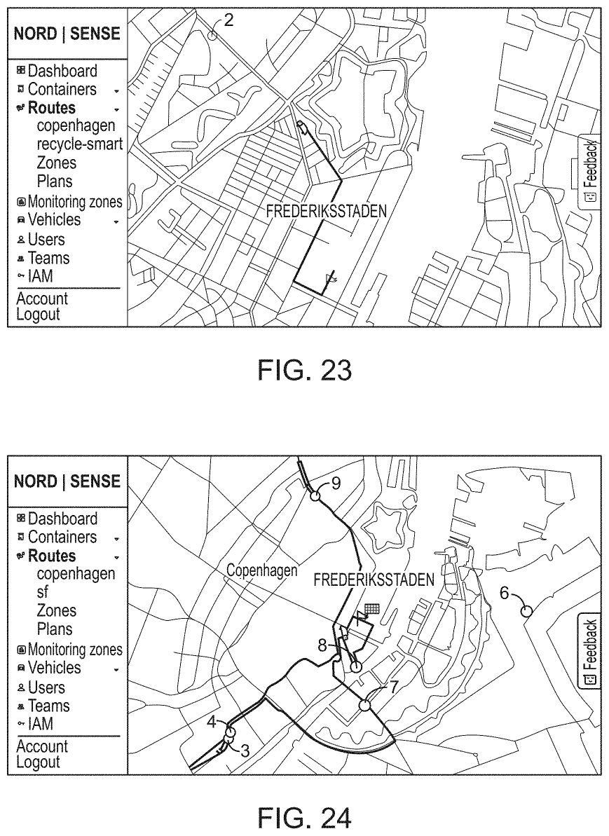

The server system 6 can monitor operators' positions in real-time through communications from the navigation app. FIG. 23a illustrates a screenshot of a map tracking a location of a collection vehicle in real-time. The area map, starting point 126 (a flag), route already driven (a line), current location (truck icon), containers already picked up (numbered circles on the route already driven), and containers to be picked up (numbered circles) are displayed. The containers displayed on the map are numbered by their order in the pickup sequence.

FIG. 24 illustrates a screenshot showing that the server system 6 can display a route summary and replay of the operators' position from a previous route (or a partially-completed route).

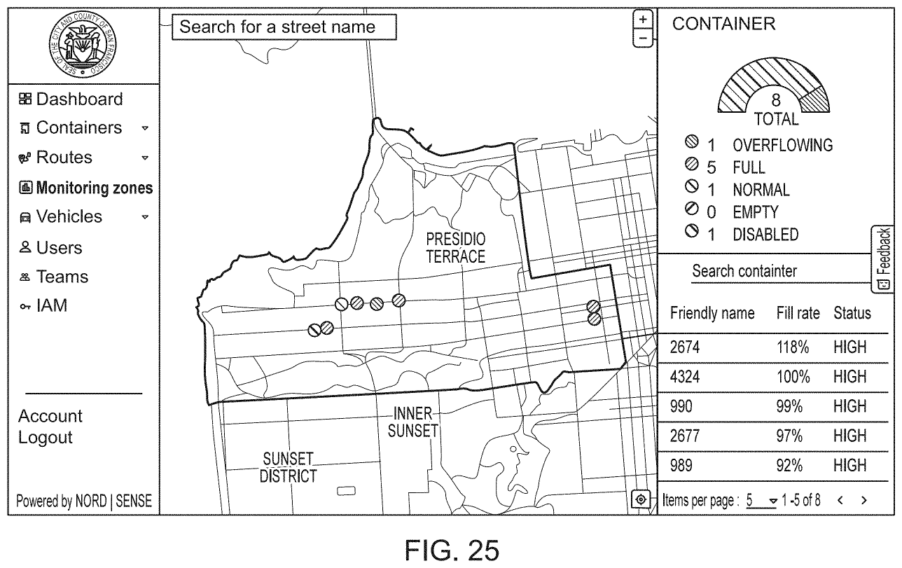

As shown in FIG. 25, the server system 6 can allow a user to manually (or set the server system 6 to automatically) group sensor data from different sensors, for example for the sensors defined within the borders drawn on the map in FIG. 25. The grouped sensor data can be combined and analyzed as a single data set.

The server system 6 can be set (e.g., by an API) to restrict access to some sensors and/or some data for different APIs based on the API type, the individual user account, the location of the user, the user's team (e.g., restrict access to collections operators, but not to collections managers), or combinations thereof.

The server system 6 data can be accessed by urban planners, for example, to place public waste containers in locations where waste is collecting in public waste containers more rapidly compared to the average public waste container in the larger area, as measured by the system, and to remove or move public waste containers from areas where waste is collecting in public waste containers less rapidly compared to the average public waste container in the larger area.

Cameras on the operators vehicles, and the waste collection centers, in the sensors, or combinations thereof, can record images and send them to the server system 6 to identify (manually and/or via machine vision algorithms) the detailed identity of the contents 40 of the waste. These identified contents 40 and their quantity can be used for consumer and/or producer behavior monitoring and tracking changes in consumer habits for the collection address.

The server system 6 can attain localized pollution levels and their respective locations, and report the pollutions levels with aggregated route and collection data to display mapped changes in pollution emissions with respect to the increased efficiency of container 32 collections.

The navigator app can direct the route 124 for operators, for example, when driving in or riding on collections vehicles or on foot. The navigator app can display and audibly announce turn-by-turn navigation along the route 124 with spoken directions. The navigator app can deliver traffic-aware routing and hands free directions to the operator. The navigator app language can be selected by the operator.

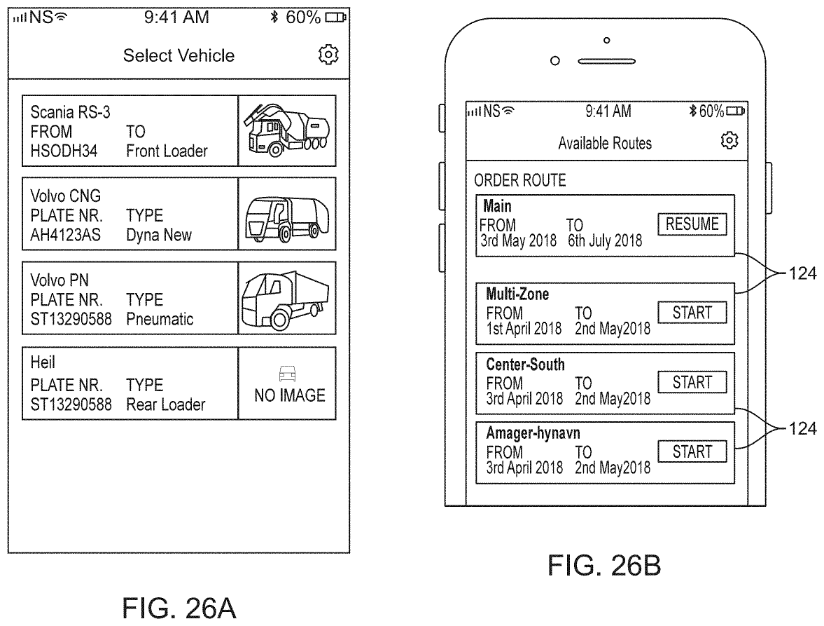

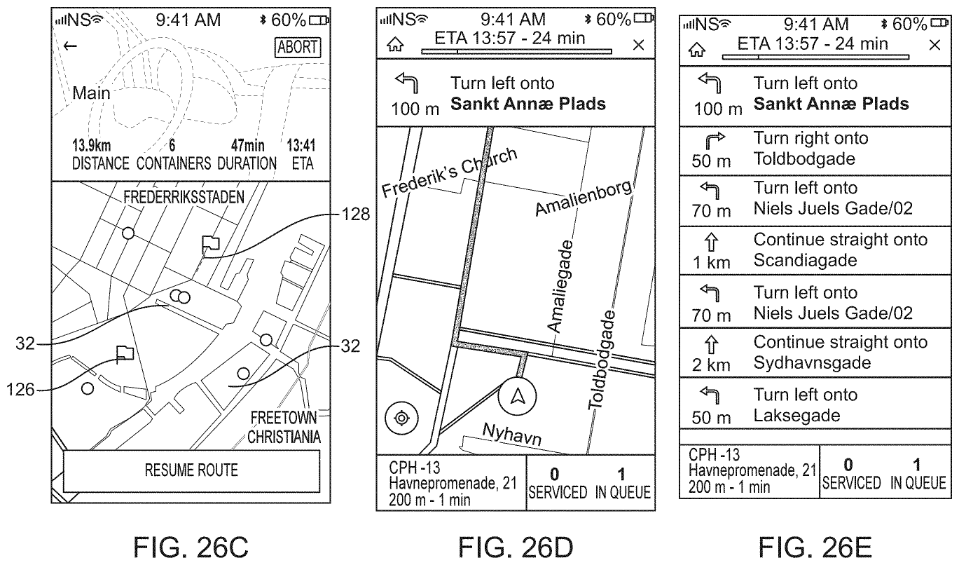

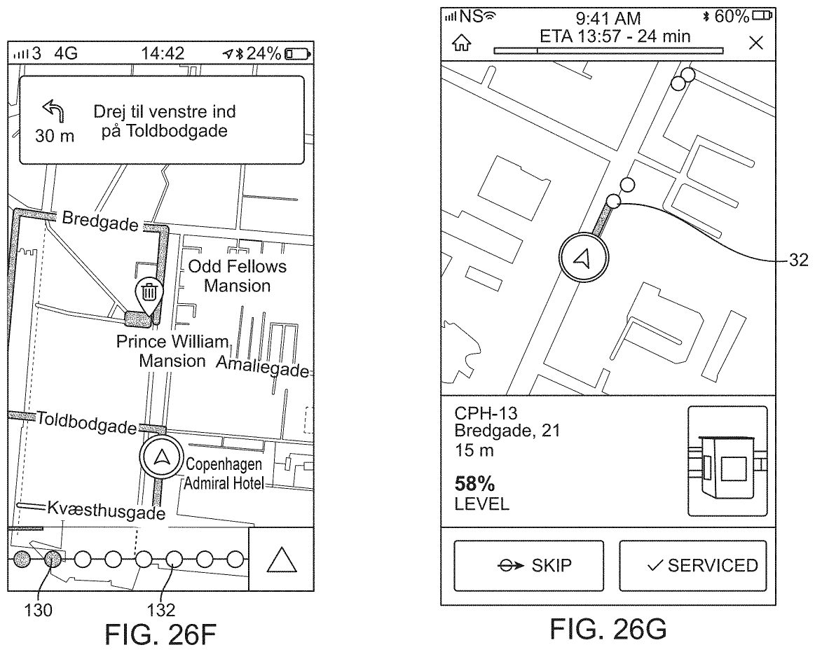

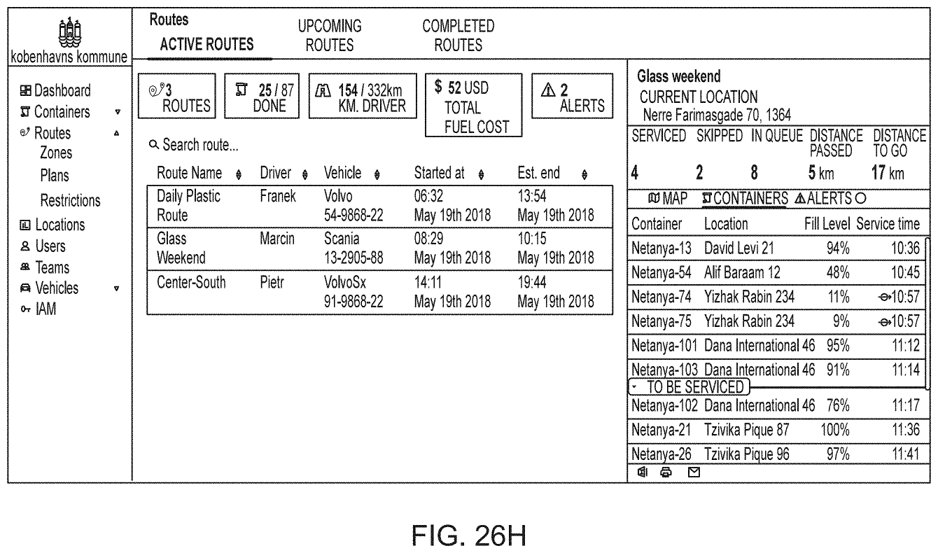

FIG. 26a illustrates that the navigator app can display available vehicles and allow the operator to identify and communicate with the server system 6 which vehicle the operator will be operating of the available vehicles. The navigator app can be on a mobile device 10 fixed to a vehicle and, for example, can prohibit the operator from selecting the vehicle.

FIG. 26b illustrates that the navigator app can allow the operator to start one or a number of routes 124. The server system 6 can show routes in the navigator app that are allowed for the vehicle the operator selected and/or the vehicle for which the navigator app is assigned (e.g., for a navigator app running on a mobile device 10 fixed to a vehicle). The navigator app can list or rank the routes in chronological order for which the operator is to proceed. The navigator app can lock out the operator from opening later routes until the earlier routes are complete and/or until a start time is reached for the route 124.

FIG. 26c illustrates that once a route 124 is selected, the navigator app can display a map showing the containers for collection and the start 126 and end 128 points for the route 124. The navigator app also can display the name of the route 124, the distance of the route 124, the number of containers to be collected, the estimated time to complete the route 124 (“47 min”, as shown in FIG. 36b), and the estimated time at which the route 124 will be completed (“13:41” as shown in FIG. 36b). The navigator app can provide the options to abort the route 124 and/or to resume the route 124.

FIGS. 26d and 26e illustrate that the navigator app can display turn-by-turn instructions to proceed along the route 124. FIG. 26d illustrates that the route 124 can be projected on a map. FIG. 26e illustrates that the route 124 can be shown as a list of turns and straights. The navigator app can display the number of served containers 32 and the number of containers 32 in the queue to be serviced along the rest of the route 124.

The navigator app can communicate special instructions for the operator during container 32 collection (e.g., “Container 3 is immediately behind the gate on the right side of the house.”, “The dog is loose in the yard but is friendly.”, “Container 7 needs its sensor cleaned.”).

FIG. 26f illustrates that the navigator app can graphically display the number of containers to collect 132 during the route 124 (shown by white circles in FIG. 26d) and the number of containers already collected 130 (shown by black circles in FIG. 26d).

FIG. 26g illustrates that the navigator app can display container 32 information, for example for the next container 32 along the route 124 or a container 32 selected by the operator on the display. The navigator app can show the fill level, the type of container 32, the container 32 identifying number or name, the container 32 address, the distance to the container 32, and a photographic image of the container 32. The image can include the visual appearance of the container 32 and the container's 32 surroundings. The navigator app can allow the operator to press on a button image on the display to indicate (e.g., to the navigator app and the server system 6) when the container 32 is serviced, or if the operator is going to skip servicing the container 32.

FIG. 26h illustrates that the navigator app, and/or the other APIs or apps can display historical and/or real-time (i.e., current) route information for multiple operators and vehicles.

The navigator app can communicate gate or door passcode information to the operator, and/or send a wireless access code to the gate or door to unlock or otherwise permit access through the gate or door, for example, to permit the operator to retrieve a container 32 from behind the gate or door.

The navigator app can communicate to the server system 6 the time the operator is at a location, the velocity, acceleration, the directional orientation of the operator and/or the operator's vehicle, the identity and classification (e.g., professional title and/or responsibility level) of the operator, when and where the operator stops, when and where the operator loads the contents 40 of a container 32 into the vehicle, the weight of the contents 40 (e.g., communicated wirelessly from a scale on the vehicle or container 32 to the mobile device 10), the identity of the operator's vehicle. The server system 6 can track the operator in real-time, for example through the data from the navigator app, and can record the navigator app data for analysis and replay.

The navigator app can supplement or alter the route 124 from the server system 6 due to data updates from sources other than the server system 6 (e.g., an immediate traffic update from a third party source). When the navigator app changes the route 124 from the route provided by the server system 6, the navigator app can alert the server system 6 of the route change. The server system 6 can confirm or abort the route change from the navigator app.

If the operator deviates from the route 124, the navigator app can alert the server system 6 of the deviation.

The server system 6 can create and display reports through the APIs or apps for any of the sensor data, mobile device 10 data, and/or server system 6 data.

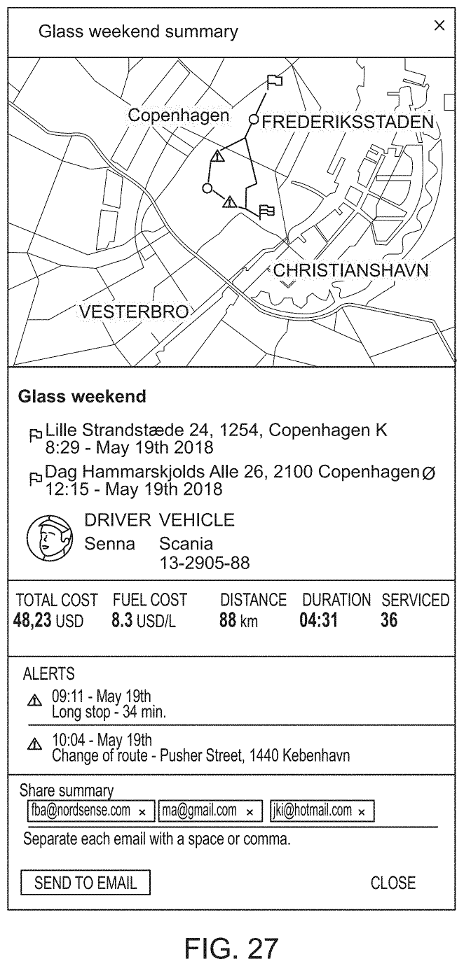

FIG. 27 illustrates that, in addition to the reports disclosed elsewhere herein, when an operator's route is complete, the server system 6 can produce a report that can display a trip summary for the route 124. The trip summary report can include a map of the route inclusive of mapped locations of the containers collected during the route, the number of total containers serviced, the start and stop times and locations, the distance and time traveled, the vehicle used and its identifying information (e.g., license plate, vehicle identification number), the gas (or electrical) mileage for the vehicle, alerts, the current cost of gas (or electrical charge), and the total cost of gas (or electricity) for the route, the depreciation and estimated wear and tear costs for route for the vehicle based on depreciation and wear and tear cost rates for the vehicle, or combinations thereof. Any reports can be shared over e-mail to the operator or others, as shown in FIG. 27.

Use of the systems and methods disclosed herein have mitigated container over-flows, reduced owner complaints, reduced the number of daily collections by 91%, reduced service route times from 4.5 hours to about 25 minutes (i.e., reduction of route time by 91%), optimized placement of trash bins, resulted in a 93% reduction in street cleaning requests.

Any method or apparatus elements described herein as singular can be pluralized (i.e., anything described as “one” can be more than one). Any of the APIs listed herein can be apps and vice versa. Any species element of a genus element can have the characteristics or elements of any other species element of that genus. The above-described configurations, elements or complete assemblies and methods and their elements for carrying out the disclosure, and variations of aspects of the disclosure can be combined and modified with each other in any combination.

We claim:

1. A method for the collection of contents of one or more geographically distributed containers comprising:
determining a fill level of the contents in one of the containers, wherein the determining comprises detecting the position of one point or more than one point on the surface of the contents;
transmitting to a server system the fill level of the contents and an identity of the one of the containers;
calculating by the server system whether to include the container in a route data set defining a route, wherein the route comprises stops at one or more of the containers;
creating the route data set;
wirelessly sending the route data set from the server system to a mobile device.

2. The method of claim 1, wherein the container comprises a sensor for determining the fill level.

3. The method of claim 2, wherein the determining of the fill level comprises forming a topography of the surface.

4. The method of claim 1, further comprising attaching a time of determination in a data set with the fill level and the identity of the one of the containers, and wherein the transmitting comprises transmitting the data set to the server system.

5. A system for the collection of contents of one or more geographically distributed containers comprising:
one or more sensors for detecting the amount of contents in a container, wherein the one or more sensors comprises one or more detectors for detecting more than one point on the surface of the contents, wherein the container comprises a lid, and wherein a first sensor of the one or more sensors is attached to the lid;
a server system in wireless communication with the one or more sensors, wherein the one or more sensors transmit data to the server, wherein the data comprises a fill level of the contents in the container;
a mobile device in wireless communication with the server system, wherein the mobile device displays instructions for routing a collection vehicle to the container.

6. The system of claim 5, wherein a first sensor of the one or more sensors is a time of flight sensor.

7. The system of claim 5, wherein a first sensor of the one or more sensors emits a first sensing energy, and wherein the first sensing energy comprises a laser.

8. The system of claim 5, wherein the one or more sensors comprise a first sensor and a second sensor, and wherein the container comprises a lid, and wherein the first sensor is attached to the lid, wherein the first sensor is configured to emit a sensing energy comprising a laser, wherein the second sensor is configured to emit a second energy comprising a laser, and wherein the first sensor is spaced at a distance from the second sensor.

9. The system of claim 8, wherein the second sensor is attached to an inside wall of the body.

10. The system of claim 5, wherein a first sensor of the one or more sensors comprises a first emitter for emitting a first sensing energy and a second emitter for emitting a second sensing energy, wherein the first emitter is directed to a first point on the surface of the contents, and wherein the second emitter is directed to a second point on the surface of the contents.

11. A device for fill volume detection comprising:
a container having a body and a lid hingedly attached to the body, wherein the container contains contents defining the fill volume within the container; and
a first sensor in the container, wherein the first sensor comprises a first emitter for emitting a first sensing energy, a first detector for detecting a reflection of the first sensing energy, and a first wireless radio; and
wherein the first emitter is oriented so the first sensing energy is emitted in the direction of the surface of the contents, wherein the first sensor comprises a time of flight sensor, and wherein the first sensing energy comprises a laser.

12. The device of claim 11, further comprising a second sensor comprising a second emitter for emitting a second sensing energy, a second detector for detecting a reflection of the second sensing energy, and a second wireless radio.

13. The device of claim 12, wherein the second sensing energy comprises no laser energy.

14. The device of claim 12, wherein the second sensor is attached to an inside lateral wall of the body.

15. The device of claim 11, wherein the first sensor further comprises a second emitter for emitting a second sensing energy, and a second detector for detecting a reflection of the second sensing energy.

16. A method for fill volume detection comprising:
emitting a sensing energy from a sensor in a container, wherein the container contains contents defining the fill volume within the container, wherein the emitting comprises directing the sensing energy to one or multiple points on the surface of the contents; and
detecting reflections of the sensing energy off of the one or multiple points of the surface of the contents;
tracking the amount of time elapsed between the emitting of the sensing energy and the detecting of the reflections of the sensing energy;
calculating a length associated with the amount of time for reflections of the sensing energy for each of the multiple points;
forming a topography of the surface of the contents, wherein the forming comprises utilizing the calculated lengths.

17. The method of claim 16, further comprising calculating the fill volume comprising processing the topography.

18. The method of claim 16, wherein the forming comprises displaying a three-dimensional image.

19. The method of claim 16, wherein the container comprises a body and a lid hingedly attached to the body.

20. The method of claim 16, wherein the emitting comprises emitting from a first sensor in the container, wherein the first sensor comprises a first emitter for emitting the first sensing energy, a first detector for the detecting a reflection of the first sensing energy, and a first wireless radio.
